(19) United States
(12) Patent Application Publication
(10) Pub. No.: US 2017/0018342 A1
(43) Pub. Date: Jan. 19, 2017

(54) R-T-B BASED SINTERED MAGNET AND METHOD FOR PRODUCING SAME

(71) Applicant: HITACHI METALS, LTD., Tokyo (JP)

(72) Inventors: Tomoki FUKAGAWA, Mishima-gun (JP); Noriyuki NOZAWA, Mishima-gun (JP); Takeshi NISHIUCHI, Mishima-gun (JP); Daisuke FURUSAWA, Mishima-gun (JP); Shinichiroh SAKASHITA, Mishima-gun (JP)

(73) Assignee: HITACHI METALS, LTD., Tokyo (JP)

(21) Appl. No.: 15/121,865

(22) PCT Filed: Feb. 27, 2015
(86) PCT No.: PCT/JP2015/055874

§ 371 Date: Aug. 26, 2016

(30) Foreign Application Priority Data
Feb. 28, 2014 (JP) 2014-037838
Sep. 29, 2014 (JP) 2014-198073

(51) Int. Cl. H01F 1/057; B22F 3/16; B22F 3/26; C22C 38/32; C22C 38/30; H01F 41/02; C22C 38/20; C22C 38/06; C22C 38/04; C22C 38/02; C22C 38/00; B22F 9/04; B22F 1/00; C22C 38/28

(52) U.S. Cl. CPC H01F 1/0577; B22F 1/0003; B22F 3/16; B22F 3/26; C22C 38/32; C22C 38/30; C22C 38/28; C22C 38/20; C22C 38/06; C22C 38/04; C22C 38/02; C22C 38/005; C22C 38/002; C22C 38/001; B22F 9/04; H01F 41/0293; B22F 2003/248

(57) ABSTRACT

An R-T-B based sintered magnet has a composition represented by the following formula (1) which satisfies the following inequality expressions (2) to (9):

uRwBxGazAlvCoqTigFejM (1)

(R is at least one of rare-earth elements and indispensably includes Nd, M is an element except for R, B, Ga, Al, Co, Ti, and Fe, and u, w, x, z, v, q, g, and j are expressed in terms of % by mass).

29.0≦u≦32.0 (2)

(heavy rare-earth elements RH account for 10% by mass or less of the R-T-B based sintered magnet)

0.93≦w≦1.00 (3)

0.3≦x≦0.8 (4)

0.05≦z≦0.5 (5)

0≦v≦3.0 (6)

0.15≦q≦0.28 (7)

60.42≦g≦69.57 (8)

0≦j≦2.0 (9)

and satisfies other requirements.

### TECHNICAL FIELD

The present invention relates to an R-T-B based sintered magnet, and a method for producing same.

### BACKGROUND ART

An R-T-B-based sintered magnet including an R₂T₁₄B type compound as a main phase (R is at least one of rare-earth elements and indispensably includes Nd, and T is a transition metal element and indispensably includes Fe) has been known as a permanent magnet with the highest performance among permanent magnets, and has been used in various motors such as a voice coil motor (VCM) for hard disk drive, a motor for electric cars (EV, HV, PHV, etc.), and motors for industrial apparatuses, and home appliances.

The R-T-B based sintered magnet is mainly composed of a main phase made of an R₂T₁₄B compound, and a grain boundary phase located on a grain boundary portion of this main phase. The R₂T₁₄B compound as the main phase is a ferromagnetic material having high magnetization and forms the backbone of properties of the R-T-B based sintered magnet.

In the R-T-B-based sintered magnet, a coercive force H_{cJ} (hereinafter sometimes simply referred to as “H_{cJ}”) decreases at an elevated temperature to cause irreversible thermal demagnetization. Therefore, when used particularly in motors for electric cars (or motors for hybrid cars), there is a need to maintain high H_{cJ} even at an elevated temperature. To suppress irreversible thermal demagnetization at an elevated temperature, namely, to maintain high H_{cJ} even at an elevated temperature, there is a need to obtain higher H_{cJ} at room temperature.

It has been known that H_{cJ} is improved when light rare-earth elements RL (mainly, Nd and/or Pr) included in R of an R₂T₁₄B compound as a main phase are partially substituted with heavy rare-earth elements RH (mainly, Dy and/or Tb) in the R-T-B based sintered magnet. With increasing the amount of heavy rare-earth elements RH substitution, H_{cJ} is improved.

To increase H_{cJ}, numerous heavy rare-earth elements (mainly, Dy) have hitherto been added to the R-T-B-based sintered magnet. However, there arose a problem that a residual magnetic flux density Bᵣ (hereinafter sometimes simply referred to as “Bᵣ”) decreases. Therefore, there has recently been employed a method in which heavy rare-earth elements are diffused from the surface into the inside of the R-T-B-based sintered magnet to thereby increase the concentration of the heavy rare-earth elements at the outer shell part of main phase crystal grains, thus obtaining high H_{cJ} while suppressing a reduction in Bᵣ.

However, Dy has problems such as unstable supply and price fluctuations because of restriction of the producing district. Therefore, there is a need to develop technique for improving H_{cJ} of the R-T-B-based sintered magnet without using heavy rare-earth elements such as Dy as much as possible (by reducing the usage amount as much as possible).

Patent Document 1 mentions that the amount of B is limited to a relatively small amount in a specific range as compared with a conventionally used R-T-B-based alloy, and one or more metal elements M selected from among Al, Ga and Cu are included to form an R₂T₁₇ phase, and also a volume fraction of a transition metal-rich phase (R₆T₁₃M) formed from the R₂T₁₇ phase as a raw material is sufficiently secured to obtain an R-T-B-based rare-earth sintered magnet having a high coercive force while suppressing the content of Dy.

Patent Document 2 discloses that the amount of B is made smaller than that of a conventional R-T-B-based alloy and amounts of B, Al, Cu, Co, Ga, C, and O are adjusted in a predetermined range, and also atomic ratio of Nd and Pr to B, and atomic ratio of Ga and C to B satisfy a specific relation to obtain high residual magnetic flux density and coercive force.

There have been proposed various methods in which a metal, an alloy, or a compound, each containing heavy rare-earth elements RH, as an improving means for H_{cJ} of an R-T-B based sintered magnet are supplied to a surface of the R-T-B based sintered magnet by a specific means, and heavy rare-earth elements RH are diffused into the inside of the magnet by a heat treatment, and also light rare-earth elements RL at the outer shell portion of an R₂T₁₄B compound are substituted with heavy rare-earth elements RH to thereby improve H_{cJ} while suppressing a reduction in Bᵣ.

For example, Patent Document 3 discloses a method in which a bulk body including an R—Fe—B-based rare-earth sintered magnet body and heavy rare-earth elements RH (at least one selected from the group consisting of Dy, Ho, and Tb) are disposed in a treatment chamber and then heated to a temperature of 700° C. or higher and 1,000° C. or lower to thereby diffuse heavy rare-earth elements RH into the inside of the R—Fe—B-based rare-earth sintered magnet body while supplying heavy rare-earth elements RH to a surface of the R—Fe—B-based rare-earth sintered magnet body from the bulk body.

Furthermore, Patent Document 4 mentions that an R-T-B-based alloy containing 4 to 10% by mass of Dy is mixed with a high melting point compound having a melting point of 1,080° C. or higher (an oxide, a boride, a carbide, a nitride, or a silicate of one selected from the group consisting of Al, Ga, Mg, Nb, Si, Ti, and Zr), and then the mixture is molded and sintered to obtain a high coercive force without increasing the Dy concentration, thus enabling suppression of degradation of magnetic properties such as magnetization (Bᵣ) due to the addition of Dy.

### PRIOR ART DOCUMENT

### Patent Document

Patent Document 1: WO 2013/008756 A
Patent Document 2: WO 2013/191276 A
Patent Document 3: WO 2007/102391 A
Patent Document 4: WO 20.10/073533 A

### DISCLOSURE OF THE INVENTION

### Problems to be Solved by the Invention

However, the inventors of the present invention have found that a sintered magnet with the composition in which the amount of B is made smaller than that of a common R-T-B based sintered magnet (made smaller than a stoichiometric ratio of the amount of B of the R₂T₁₄B type compound) and Ga is added, as mentioned in Patent Documents 1 and 2, has a problem that only a slight change in the amount of B leads to a significant change in H_{cJ}.

For example, only slight change in the amount of B by 0.01% by mass may leads to change in H_{cJ} by 100 kA/m. Whereas, in a common R-T-B based sintered magnet (including B in the amount larger than a stoichiometric ratio of the amount of B of the R₂T₁₄B type compound), H_{cJ} scarcely changes even if B changes by 0.1% by weight.

Therefore, there is a need for the R-T-B based sintered magnet, in which the amount of B is made smaller than that of the common R-T-B based sintered magnet, and Ga is added, to control the amount of B at high precision of 0.01% by mass so as to suppress a change in H_{cJ}. However, it is significantly difficult to control the amount of B at precision of 0.01% by mass when a raw material alloy is melted and subjected to casting, in a mass-production facility.

One embodiment according to the present invention (first embodiment) has been made so as to solve these problems and an object thereof is to provide an R-T-B based sintered magnet that causes little change in H_{cJ} to a change in the amount of B, and also has high Bᵣ and high H_{cJ}.

Problems according to another embodiment will be described below.

There is a need to produce an R-T-B-based alloy with new composition that is different from before in Patent Document 1, so that there is a need to find out optimum conditions of melting and casting conditions of alloys, pulverization conditions, sintering conditions, and heat treatment conditions all over from the beginning. When the respective conditions are different from current production conditions, there arise problems, that is, there is a need to change various conditions of each facility each time a new R-T-B-based alloy is produced, leading to an increase in man-hours and costs during production.

Furthermore, according to Patent Document 1, an R-T-B based sintered magnet having higher H_{cJ} than before. However, use of Dy is indispensable to satisfy high H_{cJ} required when used in motors for electric cars, motors for hybrid cars, and the like. Therefore, there is nothing to do but to apply a method in which heavy rare-earth elements are supplied from a surface of an R-T-B based sintered magnet and diffused into the inside, as disclosed in Patent Document 3, so as to reduce the usage amount of Dy.

However, when the method disclosed in Patent Document 3 is applied to an R-T-B-based rare-earth sintered magnet disclosed in Patent Document 1, there arises a problem such as drastic decrease in squareness ratio Hₖ/H_{cJ} (hereinafter sometimes simply referred to as “Hₖ/H_{cJ}”. Hₖ is the value of H at the position where J becomes a given proportion of the value to the value of Jᵣ [residual magnetization=Bᵣ] in a second quadrant of a J [magnitude of magnetization]−H [intensity of magnetic field]curve. In the R-T-B based sintered magnet, 0.9×Jᵣ [0.9×Bᵣ] is often used as a given proportion of the value).

According to Patent Document 4, a high coercive force can be obtained without increasing Dy concentration. Because of significantly large amount of Dy included in an R-T-B-based alloy (4 to 10% by mass in an R-T-B-based alloy), it is impossible to satisfy users' requirements of improving H_{cJ} without causing degradation of Bᵣ, without using heavy rare-earth elements RH as much as possible.

Furthermore, in Patent Document 4, an oxide, a boride, a carbide, a nitride, or a silicate of one selected from the group consisting of Al, Ga, Mg, Nb, Si, Ti, and Zr is used as a high melting point compound. There is a possibility that oxygen, boron, carbon, nitrogen, silicon, and the like included in the compounds remain in a magnet even after sintering to thereby cause degradation of magnetic properties of the thus obtained magnet.

An object of the other one embodiment (second embodiment) according to the present invention is to provide an R-T-B based sintered magnet having high H_{cJ} and high Hₖ/H_{cJ} at low cost while suppressing a reduction in Bᵣ without using heavy rare-earth elements RH as much as possible.

### Means for Solving the Problems

An aspect 1-1 of the first embodiment according to the present invention is directed to an R-T-B based sintered magnet, wherein the composition represented by the following formula (1) satisfies the following inequality expressions (2) to (9):

uRwBxGazAlvCoqTigFejM (1)

(R is at least one of rare-earth elements and indispensably includes Nd, M is an element except for R, B, Ga, Al, Co, Ti, and Fe, and u, w, x, z, v, q, g, and j are expressed in terms of % by mass)

29.0≦u≦32.0 (2)

(heavy rare-earth elements RH account for 10% by mass or less of the R-T-B based sintered magnet)

0.93≦w≦1.00 (3)

0.3≦x≦0.8 (4)

0.05≦z≦0.5 (5)

0≦v≦3.0 (6)

0.15≦q≦0.28 (7)

60.42≦g≦69.57 (8)

0≦j≦2.0 (9)

and, when the value obtained by dividing g by the atomic weight of Fe is g′, the value obtained by dividing v by the atomic weight of Co is v′, the value obtained by dividing z by the atomic weight of Al is z′, the value obtained by dividing w by the atomic weight of B is w′, and the value obtained by dividing q by the atomic weight of Ti is q′, the following inequality expressions (A) and (B) are satisfied.

0.06≦(g′+v′+z′)−(14×(w′−2×q′)) (A)

0.10≧(g′+v′+z′)−(14×(w′−q′)) (B)

An aspect 1-2 of the first embodiment according to the present invention is directed to the R-T-B based sintered magnet according to Aspect 1-1, wherein 0.18≦q≦0.28.

An aspect 1-3 of the first embodiment according to the present invention provides the R-T-B based sintered magnet according to the aspect 1-1 or 1-2, which has a structure in which:

an R₂T₁₄B compound (R is at least one of rare-earth elements and indispensably includes Nd, and T is at least one of transition metal elements and indispensably includes Fe),

an R₆T₁₃A compound (R is at least one of rare-earth elements and indispensably includes Nd, T is at least one of transition metal elements and indispensably includes Fe, and A is at least one of Ga, Al, Cu and Si and indispensably includes Ga), and

a boride of Ti coexist.

An aspect 1-4 of the first embodiment according to the present invention provides the R-T-B based sintered magnet according to any one of the aspects 1-1 to 1-3, wherein an area ratio of the R₆T₁₃A compound in an arbitrary cross section of the R-T-B based sintered magnet is 2% or more.

An aspect 2-1 of the second embodiment according to the present invention is a method for producing an R-T-B based sintered magnet, which includes the steps of:

preparing an alloy powder including:

R: 27 to 35% by mass (R is at least one of rare-earth elements and indispensably includes Nd),

B: 0.9 to 1.0% by mass,

Ga: 0.15 to 0.6% by mass, and

balance T (T is at least one of transition metal elements and indispensably includes Fe) and inevitable impurities;

preparing a powder of a hydride of Ti;

mixing the alloy powder with the powder of a hydride of Ti so as to adjust the amount of Ti included in 100% by mass of the mixed powder after mixing to 0.3% by mass or less to thereby prepare the mixed powder;

molding the mixed powder to prepare a molded body;

sintering the molded body to prepare an R-T-B based sintered magnet material; and

subjecting the R-T-B based sintered magnet material to a heat treatment.

An aspect 2-2 of the present invention is directed to the method for producing an R-T-B based sintered magnet according to the aspect 2-1, which includes the steps of:

preparing an RH diffusion source comprising a metal, an alloy, or a compound, each containing Dy and/or Tb, in place of the step of subjecting the R-T-B based sintered magnet material to a heat treatment;

subjecting to an RH supply and diffusion treatment of supplying Dy and/or Tb of the RH diffusion source to the R-T-B based sintered magnet material, and diffusing Dy and/or Tb; and

subjecting the R-T-B based sintered magnet material after the RH supply and diffusion treatment step to a heat treatment.

An aspect 2-3 of the present invention is directed to the method for producing an R-T-B based sintered magnet according to the aspect 2-1 or 2-2, which includes:

B: 0.91 to 1.0% by mass.

An aspect 2-4 of the present invention is directed to the method for producing an R-T-B based sintered magnet according to any one of the aspects 2-1 to 2-3, wherein the R-T-B based sintered magnet has a structure in which:

an R₂T₁₄B compound (R is at least one of rare-earth elements and indispensably includes Nd, and T is at least one of transition metal elements and indispensably includes Fe),

an R₆T₁₃M compound (R is at least one of rare-earth elements and indispensably includes Nd, T is at least one of transition metal elements and indispensably includes Fe, and M is at least one of Ga, Al, Cu and Si and indispensably includes Ga), and

a boride of Ti coexist.

An aspect 2-5 of the present invention is directed to the method for producing an R-T-B based sintered magnet according to the aspect 2-4, wherein an area ratio of the R₆T₁₃M compound in an arbitrary cross section of the R-T-B based sintered magnet is 1% or more.

An aspect 2-6 of the present invention is directed to the method for producing an R-T-B based sintered magnet according to the aspect 2-5, wherein an area ratio of the R₆T₁₃M compound in an arbitrary cross section of the R-T-B based sintered magnet is 2% or more.

### Effects of the Invention

According to one embodiment of the present invention, it is possible to provide an R-T-B based sintered magnet that causes little change in H_{cJ} to a change in the amount of B, and also has high Bᵣ and high H_{cJ}.

According to the other one embodiment of the present invention, it is possible to provide an R-T-B based sintered magnet having high H_{cJ} and high Hₖ/H_{cJ} at low cost while suppressing a reduction in Bᵣ without using heavy rare-earth elements RH as much as possible.

### BRIEF DESCRIPTION OF THE DRAWINGS

FIG. 1 is a photograph of a reflected electron image taken by FE-SEM of sample No. 25 according to the first embodiment.

FIG. 2 is an explanatory view showing spectral data of EDX at an analytical position 3 according to the first embodiment.

FIG. 3 is a photograph observed by using FE-SEM after extraction at a position of a dotted line of FIG. 1 in a depth direction using FIB.

FIG. 4 is an explanatory view showing the results of analysis of a crystal structure of a granular crystal according to the first embodiment by electron diffraction.

FIG. 5 is an explanatory view showing the results of analysis of a crystal structure of a needle crystal according to the first embodiment by electron diffraction.

FIG. 6 is a photograph of a reflected electron image by FE-SEM of sample No. 20 according to the first embodiment.

FIG. 7 is a photograph of a reflected electron image by FE-SEM of sample No. 21 according to the first embodiment.

FIG. 8 is a graph showing a relationship between the amount of Ti and H_{cJ} of an R-T-B based sintered magnet of Example 3 according to the second embodiment.

FIG. 9 is a graph showing a relationship between the amount of Ti and Bᵣ of an R-T-B based sintered magnet of Example 3 according to the second embodiment.

FIG. 10 is a graph showing a relationship between the amount of Ti and Hₖ of an R-T-B based sintered magnet of Example 3 according to the second embodiment.

FIG. 11 is a graph showing a relationship between the amount of Ti and Hₖ/H_{cJ} of an R-T-B based sintered magnet of Example 3 according to the second embodiment

FIG. 12 is a graph showing a relationship between the amount of Ti and H_{cJ} of an R-T-B based sintered magnet of Example 4 according to the second embodiment.

FIG. 13 is a photograph showing the results of FE-TEM structure observation of an R-T-B based sintered magnet of Example 5 according to the second embodiment.

FIG. 14 is a photograph showing a diffraction pattern which characterizes a crystal structure of an electron diffraction at a site “a” of FIG. 13 according to the second embodiment.

FIG. 15 is a photograph showing a diffraction pattern which characterizes a crystal structure of an electron diffraction at a site “b” of FIG. 13 according to the second embodiment.

FIG. 16 is a photograph showing a diffraction pattern which characterizes a crystal structure of an electron diffraction at a site “c” of FIG. 13 according to the second embodiment.

FIG. 17 is a graph showing the results of X-ray diffraction of TiB₂ according to the second embodiment.

FIG. 18 is a graph showing the results of X-ray diffraction of an Nd₆Fe₁₃Ga alloy according to the second embodiment.

### MODE FOR CARRYING OUT THE INVENTION

Embodiments of the present invention will be described in detail with reference to the accompanying drawings. In the description below, if necessary, the terms indicative of the specific direction or position (for example, “upper”, “lower”, “right”, “left”, and other words including these words) are used for easy understanding of the present invention with reference to the drawings. The meanings of the terms are not intended to restrict the scope of the present invention.

### 1. First Embodiment

The inventors have intensively studied and found that sintered magnet shows a change in H_{cJ} to a change in the amount of B is suppressed. The sintered magnet has a composition, in which titanium is added so as to adjust to the content in a specific range to form a boride of titanium during the production process, whereby, the amount of B obtained by subtracting the amount of B, consumed as a result of bonding with Ti during the production process, from the amount of B of the entire R-T-B based sintered magnet (hereinafter, residual amount of B, which does not form a boride with Ti, is sometimes referred to as an effective amount of B “amount of B_{eff}”) is made smaller than the amount of B of the entire common R-T-B based sintered magnet (less than the amount of B of a stoichiometric ratio of an R₂T₁₄B type compound); and Ga and the like are also added. The inventors have also confirmed that, when such addition of Ti is performed, high Bᵣ and high H_{cJ} are obtained, as well as the effect recognized in a sintered magnet in which the amount of B is made smaller than a stoichiometric ratio of an R₂T₁₄B type compound, and Ga is added.

### 1-1. Regarding Addition of Ti

The inventors have confirmed that a boride of Ti (TiB and/or TiB₂) is formed in an R-T-B based sintered magnet according to this embodiment. In this embodiment, a boride of Ti is formed so that the amount of B_{eff} becomes less than the amount of B of a common R-T-B based sintered magnet. A mechanism in which inclusion of a predetermined content of Ti enables suppression of a change in H_{cJ} even if the amount of B changes, proposed by the inventors based on the above-mentioned confirmation, is as follows. Note that the mechanism mentioned below is not intended to limit the scope of the invention according to this embodiment.

As mentioned above, it is possible for a sintered magnet, which employs the composition in which the amount of B is made smaller than that of a common R-T-B based sintered magnet (less than the amount of B of a stoichiometric ratio of an R₂T₁₄B type compound), and also Ga is added, to obtain high H_{cJ}.

The reason is considered as follows. That is, when the amount of B is less than a stoichiometric ratio of an R₂T₁₄B type compound, a R₂T₁₇ phase is formed because of excessive R and T. Usually, magnetic properties are quickly degraded with the decrease of the amount of B. However, if the magnet composition contains Ga, an R-T-Ga phase (a representative example is an R₆T₁₃A compound) is formed in place of the R₂T₁₇ phase, thus obtaining high H_{cJ}.

As used herein, “R-T-Ga phase” includes those including: R: 20 atomic % or more and 35 atomic % or less, T: 55 atomic % or more and 75 atomic % or less, and Ga: 3 atomic % or more and 15 atomic % or less, and a typical example is an R₆T₁₃Ga compound. The R-T-Ga phase sometimes includes, as inevitable impurities, Al, Si, Cu and the like, and the phase can be defined as an R₆T₁₃A compound (R is at least one of rare-earth elements and indispensably includes Nd, T is at least one of transition metal elements and indispensably includes Fe, A is at least one of Ga, Al, Cu, and Si and indispensably includes Ga). For example, the compound is sometimes an R₆T₁₃(Ga_{1-i-y-s}AlᵢSi_{y}Cuₛ) compound.

However, as mentioned above, in the sintered magnet, which employs the composition in which the amount of B is made smaller than that of a common R-T-B based sintered magnet, and also Ga is added, H_{cJ} significantly changes when the amount of B changes. The reason is considered as follows. That is, since the amount of the R-T-Ga phase formed significantly changes according to how much the amount of B become less than a stoichiometric ratio of an R₂T₁₄B type compound (how much do R and T become excessive), it is considered that dependency of H_{cJ} on the amount of B increases.

Whereas, the inventors have intensively studied and found that, when the amount of B_{eff} is made smaller than the amount of B of a stoichiometric ratio of an R₂T₁₄B type compound by adding Ti to form a boride (TiB and/or TiB₂), it is possible to reduce dependency of H_{cJ} on the amount of B of the entire magnet.

The reason is considered as follows. That is, like this embodiment, when the amount of B_{eff} is made smaller than the amount of B of a common R-T-B based sintered magnet, by forming a boride of Ti in an R-T-B based sintered magnet with the composition in which the amount of B is more than the amount of B determined from a stoichiometric ratio of an R₂Fe₁₄B type compound, the addition of Ga leads to suppression of formation of an R₂T₁₇ phase to form an R-T-Ga phase, thus improving H_{cJ}. At this time, when the amount of B of the entire magnet composition changes to the amount of B of a stoichiometric ratio of an R₂T₁₄B type compound, a formation ratio of TiB to TiB₂ changes. Namely, when there is a small difference between the amount of B of the entire magnet composition and the amount of B determined from a stoichiometric ratio of an R₂T₁₄B type compound (namely, smaller amount of B contained), TiB is formed in a larger amount than that of TiB₂. In contrast, when there is a large difference between the amount of B of the entire magnet composition and the amount of B determined from a stoichiometric ratio of an R₂T₁₄B type compound (namely, larger amount of B contained), TiB₂ is formed in a larger amount than that of TiB. As mentioned above, a B-rich Ti boride (TiB₂) is formed as B increases, while a B-poor Ti boride (TiB) is formed as B decreases. Therefore, it is possible to reduce a change in the amount of B (amount of B_{eff}), which does not form a Ti compound with Ti in the magnet, even if the amount of B of the entire magnet changes. As a result, it is possible to reduce a change in the formation amount of an R-T-Ga phase to a change in the amount of B, thus enabling suppression of a change in H_{cJ}.

Based on the above-mentioned these considerations, the inventors have further studied and found that it is possible to adjust the formation amount of an R-T-Ga phase in an appropriate range when the amount of Ti and the amount of B satisfy the formula (A) and the formula (B), thus making it possible to obtain high Bᵣ and high H_{cJ} while suppressing a change in H_{cJ} to a change in the amount of B:

0.06≦(g′+v′+z′)−(14×(w′−2×q′)) (A)

0.10≧(g′+v′+z′)−(14×(w′−q′)) (B)

where g′ is the value obtained by dividing g by the atomic weight of Fe (55.845), v′ is the value obtained by dividing v by the atomic weight of Co (58.933), z′ is the value obtained by dividing z by the atomic weight of Al (26.982), w′ is the value obtained by dividing w by the atomic weight of B (10.811), and q′ is the value obtained by dividing q by the atomic weight of Ti (47.867).

The formula (A) and the formula (B) will be described below.

When the amount of B_{eff} is lower than a stoichiometric ratio of the R₂T₁₄B type compound, Fe, and Co and Al capable of easily replacing a Fe site of a main phase become excessive (namely, the total amount of Fe, Co, and Al becomes more excessive than the amount of T of a stoichiometric ratio of the R₂T₁₄B type compound). Therefore, when the entire Ti becomes TiB₂ (namely, when Ti is bonded with the largest number of B), there is a need that [(g′+v′+z′)−(14×(w′−2×q′))](the total of Fe, Co, and Al that does not form a main phase) is larger than 0 (Fe, Co, and Al becomes excessive) so as to make the amount of B_{eff} less than the amount of B of a stoichiometric ratio of an R₂T₁₄B type compound. It is the formula (A) defining that the total of Fe, Co, and Al, which do no form this main phase, is 0.06 or more. It is possible to appropriately form an R-T-Ga phase by adjusting to 0.06 or more. It is possible to determine the formula (A) by calculating using, as analytical values of Fe(g), Co(v), Al(z), B(w), and Ti(q), the values (g′, v′, z′, w′, and q′) divided by each atomic weight of Fe, Co, Al, B, and Ti. The same shall apply to the formula B mentioned below.

When the total of Fe, Co, and Al, which do not form a main phase, is less than 0.06, it may become impossible to obtain high H_{cJ} because of too small phase proportion of an R-T-Ga phase.

Furthermore, in this embodiment, the formula (B) defines that [(g′+v′+z′)−(14×(w′−q′))](the total of Fe, Co, and Al that does not form a main phase) is 0.10 or less when the entire Ti becomes TiB (namely, when Ti is bonded with the smallest number of B). When the total of Fe, Co, and Al, which do not form a main phase, exceeds 0.10, it may become impossible to obtain high Bᵣ because of too high proportion of an R-T-Ga phase.

As mentioned above, the R-T-B based sintered magnet of this embodiment may have a structure in which an R₂T₁₄B compound, an R₆T₁₃A compound, and a boride of Ti (TiB₂ or TiB, and TiB₂) coexist. In a preferable aspect, in the R-T-B based sintered magnet of this embodiment, an R₆T₁₃A compound is included in an area ratio of 2% or more in an arbitrary cross section thereof. It is possible to determine the area ratio of the R₆T₁₃A compound by analyzing an image of a reflected electron image (BSE image) of an arbitrary cross section of the R-T-B based sintered magnet, which is observed by a field emission-type scanning electron microscope (FE-SEM), using commercially available an image processing software, as shown in the below-mentioned Examples.

As used herein, “arbitrary cross section” means an arbitrary cross section selected based on rational expectations that typical feature of an R-T-B based sintered magnet according to the present invention, like a cross section including the center portion, and does not include a cross section selected arbitrarily so as not to disclose the feature of the present invention.

### 1-2. Composition

The composition of an R-T-B based sintered magnet according to this embodiment will be described in detail below.

As mentioned above, in this embodiment, Ti is added to form a boride of Ti, thus reducing the amount of B_{eff} to less than the amount of B of a common R-T-B based sintered magnet, and Ga is included. Whereby, an R-T-Ga phase is formed on a grain boundary and, even if the content of heavy rare-earth elements such as Dy is suppressed, high H_{cJ} can be obtained.

The composition of an R-T-B based sintered magnet according to this embodiment can be represented by the formula (1):

uRwBxGazAlvCoqTigFejM (1)

(R is at least one of rare-earth elements and indispensably includes Nd; M is an element except for R, B, Ga, Al, Co, Ti, and Fe; and u, w, x, z, v, q, g, and j are expressed in terms of % by mass)

Hereinafter, a description will be made of the composition ranges of individual elements, namely, numerical value ranges of u, w, x, z, v, q, g, and j.

### 1) Rare Earth Element (R)

R in the R-T-B based sintered magnet of this embodiment is at least one of rare-earth elements, and indispensably includes Nd. In the R-T-B based sintered magnet according to this embodiment, since high Bᵣ and high H_{cJ} can be obtained without using heavy rare-earth elements RH, the addition amount of RH can be reduced even when higher H_{cJ} is required, RH can be typically set at 10% by mass or less, and preferably 5% by mass or less.

As shown in the inequality expression (2), the content of R is in a range of 29.0% by mass to 32.0% by mass.

29.0≦u≦32.0 (2)

When the content of R is less than 29.0% by mass, it may be impossible to ensure R required to form a sufficient amount of an R-T-Ga phase, thus failing to obtain high H_{cJ}. When the content exceeds 32.0% by mass, the proportion of a main phase is reduced, thus failing to obtain high Bᵣ.

### 2) Boron (B)

AS shown in the inequality expression (3), the content of B is in a range of 0.93% by mass to 1.00% by mass.

0.93≦w≦1.00 (3)

The content of B of less than 0.93% by mass leads to excessive reduction in the amount of B_{eff} and precipitation of an R₂T₁₇ phase, thus failing to obtain high H_{cJ}, or the proportion of a main phase is reduced, thus failing to obtain high Bᵣ. When the content exceeds 1.00% by mass, an R-T-Ga phase is not sufficiently formed, thus failing to obtain high H_{cJ}.

### 3) Gallium (Ga)

As shown in the inequality expression (4), the content of Ga is in a range of 0.3% by mass to 0.8% by mass.

0.3≦x≦0.8 (4)

The content of Ga of less than 0.3% by mass leads to excessively small formation amount of an R-T-Ga phase, thus failing to allow an R₂T₁₇ phase to disappear and to obtain high H_{cJ}. When the content exceeds 0.8% by mass, the unnecessary Ga exists, and thus the proportion of a main phase may be reduced, leading to a reduction in Bᵣ.

### 5) Aluminum (Al)

As shown in the inequality expression (5), the content of Al is in a range of 0.05% by mass to 0.5% by mass.

0.05≦z≦0.5 (5)

Inclusion of Al enables an improvement in H_{cJ}. Al may be included as inevitable impurities, or included by positive addition. When the content of Al exceeds 0.5% by mass, Bᵣ may be reduced. Al is included in the amount of 0.05% by mass or more and 0.5% by mass or less as the total amount of Al included as inevitable impurities and Al added positively.

### 6) Cobalt (Co)

As shown in the inequality expression (6), the content of Co is 3.0% by mass or less.

0≦v≦3.0 (6)

Co may be included in the amount of 3.0% by mass or less. Co is effective for improvement of temperature properties and improvement of corrosion resistance. When the content of Co exceeds 3.0% by mass, it may be impossible to obtain high Bᵣ.

### 7) Titanium (Ti)

As shown in the inequality expression (7), the content of Ti is in a range from 0.15% by mass to 0.28% by mass.

0.15≦q≦0.28 (7)

When the content of Ti is less than 0.15% by mass, it may be impossible to suppress a change in H_{cJ} due to a change in the amount of B. When the content exceeds 0.28% by mass, the proportion of a main phase may be reduced, thus failing to obtain high Bᵣ. As shown in the inequality expression (10) mentioned below, the content is preferably in a range of 0.18% by mass or more and 0.28% by mass or less. It is possible to suppress a change in H_{cJ} due to a change in the amount of B.

0.18≦q≦0.28 (10)

### 8) Iron (Fe)

As shown in the inequality expression (8), the content of Fe is in a range of 60.42% by mass to 69.57% by mass.

60.42≦g≦69.57 (8)

When the content of Fe is less than 60.42% by mass, the proportion of a main phase may be reduced, thus failing to obtain high Bᵣ. When the content exceeds 69.57% by mass, excessive R-T-Ga phase may be formed, leading to a reduction in the proportion of a main phase, thus failing to obtain high Bᵣ.

### 9) Element M

M is an element except for R, B, Ga, Al, Co, Ti, and Fe.

As shown in the inequality expression (9), 2.0% by mass or less of an element M except for R, B, Ga, Al, Co, Ti, and Fe may be included in total.

0≦g≦2.0 (9)

Namely, the inequality expression (9) indicates that an optional element (that may be plural kinds of elements) and inevitable impurities (excluding Al when Al corresponds to inevitable impurities) may be included in the total amount of up to 2.0% by mass for the purpose of improving properties of the thus obtained R-T-B based sintered magnet.

It is possible to include, as an element capable of improving properties of an R-T-B based sintered magnet, for example, Cu, Ni, Ag, Au, Mo, and the like in the amount in a range of 0% by mass to 2.0% by mass.

It is particularly preferred to include Cu. Higher H_{cJ} can be obtained by including Cu. The content of Cu is more preferably 0.05% by mass or more and 1.0% by mass or less.

In one of preferred embodiments of M, M is composed of inevitable impurities (as mentioned above, Cu is preferably included). Examples of inevitable impurities in the R-T-B based sintered magnet of this embodiment include inevitable impurities, which are usually contained in raw materials used industrially, such as a didymium alloy (Nd—Pr alloy), electrolytic iron, ferroboron, and the like. Examples of these inevitable impurities include Cr, Mn, Si, and the like. Furthermore, examples of inevitable impurities in the production process include oxygen (O), nitrogen (N), carbon (C), and the like. Preferably, the amount of O is in a range of 600 to 8,000 ppm, the amount of N is 800 ppm or less, and the amount of C is in 1,000 ppm or less.

It is possible to employ high-frequency inductively coupled plasma emission spectrometry (ICP emission spectrometry, ICP-OES) in evaluation of u, w, x, z, v, q, g, and j, which are contents (% by mass) of R, B, Ga, Al, Co, Ti, Fe, and M shown in the formula (1), respectively. For example, a gas fusion-infrared absorption method can be employed for evaluation of the amount of oxygen. For example, a gas fusion-thermal conductivity method can be employed for evaluation of the amount of nitrogen. For example, a gas analyzer by a combustion infrared absorption method can be employed for evaluation of the amount of carbon.

### 1-3. Method for Producing R-T-B Based Sintered Magnet

An example of a method for producing an R-T-B based sintered magnet of this embodiment will be described below. The method for producing an R-T-B based sintered magnet includes a step of obtaining an alloy powder, a molding step, a sintering step, and a heat treatment step. Each step will be described below.

### (1) Step of Obtaining Alloy Powder

Metals or alloys of the respective elements are prepared so as to obtain the above-mentioned composition, followed by melting and further casting to obtain an alloy having a predetermined composition. Typically, a flaky alloy is produced using a strip casting method. The flaky alloy thus obtained is subjected to hydrogen grinding to obtain a coarsely pulverized powder having a size of 1.0 mm or less. Next, the coarsely pulverized powder is finely pulverized by a jet mill to obtain a finely pulverized powder (alloy powder) having a grain size D50 (median size on a volume basis obtained by a laser diffraction method using an air flow dispersion method) of 3 to 7 μm. One kind of an alloy powder (alloy powder alone) may be used as the alloy powder. It is also possible to use a so-called two-alloy method in which two or more kinds of alloy powders are mixed and then pulverized to obtain an alloy powder (mixed alloy powder). Alternatively, an alloy powder may be produced so as to obtain the composition of this embodiment, using a known method. A known lubricant may be used as a pulverization assistant in a coarsely pulverized powder before jet mill pulverization, or an alloy powder during and after jet mill pulverization.

Regarding the addition of Ti, in the production of a raw material alloy using a strip casting method, when a molten metal for subjecting to casting is obtained, Ti is added in the form of Ti metal, a Ti alloy, or a Ti-containing compound to obtain a molten metal containing Ti, followed by solidification. Alternatively, Ti may be added in the form of Ti metal, a Ti alloy, or a Ti-containing compound before finishing of molding and after preparation of a raw material alloy. The method includes, for example, a method in which a hydride of Ti (TiH₂, etc.) is added to an alloy powder before and after hydrogen grinding, or after jet mill pulverization.

### (2) Molding Step

Using the alloy powder thus obtained, molding under a magnetic field is performed to obtain a molded body. The molding under a magnetic field may be performed using known optional methods of molding under a magnetic field including a dry molding method in which a dry alloy powder is loaded in a cavity of a mold and then molded while applying a magnetic field, and a wet molding method in which a slurry containing the alloy powder dispersed therein is injected in a cavity of a mold and then molded under a magnetic field while discharging a dispersion medium of the slurry.

### (3) Sintering Step

The molded body is sintered to obtain a sintered magnet. A known method can be used to sinter the molded body. To prevent oxidation from occurring due to an atmosphere during sintering, sintering is preferably performed in a vacuum atmosphere or an atmospheric gas. It is preferable to use, as the atmospheric gas, an inert gas such as helium or argon.

### (4) Heat Treatment Step

The sintered magnet thus obtained is preferably subjected to a heat treatment for the purpose of improving magnetic properties. Known conditions can be employed for heat treatment temperature, heat treatment time, and the like. To impart a final product shape to the sintered magnet, the magnet may be subjected to machining such as grinding. In that case, the heat treatment may be performed before or after machining. The sintered magnet may also be subjected to a surface treatment. The surface treatment may be a known surface treatment, and it is possible to perform surface treatments, for example, Al vapor deposition, Ni electroplating, resin coating, and the like.

### 2. Second Embodiment

This embodiment is characterized in that a predetermined amount of a powder of a hydride of Ti (hereinafter sometimes referred to as “Ti hydride powder”) is added to an alloy powder with the composition, which is almost the same as in a conventional R-T-B based sintered magnet (composition containing R, B, Ga, Fe and the like, the amount of B being high [0.9 to 1.0% by mass] as compared with the sintered magnet of Patent Document 1). Whereby, it is possible to provide an R-T-B based sintered magnet having high H_{cJ} and high Hₖ/H_{cJ} while suppressing a reduction in Bᵣ without using heavy rare-earth elements RH as much as possible.

The reason why the R-T-B based sintered magnet according to this embodiment has high H_{cJ} and high Hₖ/H_{cJ} while suppressing a reduction in Bᵣ is not clear. However, it is considered that the addition of a Ti hydride powder leads to formation of an R₆T₁₃M compound (typically, an Nd₆Fe₁₃Ga compound) and a boride of Ti (typically, a TiB₂ compound) during sintering and/or a heat treatment.

According to this embodiment, since an alloy powder with the composition, which is almost the same as that of a conventional R-T-B based sintered magnet, is used, H_{cJ} does not cause significant change (quick reduction) by a slight change in the amount of B. There is not a need to use a new alloy, a new step, and the like, and existing production conditions can be basically applied as they are. Therefore, it becomes possible to provide a sintered magnet having high H_{cJ}, which is equal to or higher than that of the sintered magnet of Patent Document 1, at low cost.

The R-T-B based sintered magnet according to this embodiment enables suppression of a reduction in Hₖ/H_{cJ} due to a RH supply and diffusion treatment. This reason is not also clear, but is considered that the addition of a Ti hydride powder leads to formation of an R₆T₁₃M compound and a boride of Ti during sintering and/or a heat treatment, similarly as mentioned above.

Meanwhile, in Patent Document 4, oxygen, boron, carbon, nitrogen, silicon, and the like included in a high melting point compound (an oxide, a boride, a carbide, a nitride, or a silicate of one selected from the group consisting of Al, Ga, Mg, Nb, Si, Ti, and Zr) may remain in the magnet even after sintering, leading to a reduction in magnetic properties of the thus obtained magnet. The Ti hydride powder used in this embodiment is decomposed into Ti and H₂ (hydrogen) during the sintering step, and hydrogen is released into a sintering furnace from the magnet, and discharged finally out of the sintering furnace. Therefore, magnetic properties may be scarcely degraded.

As mentioned above, according to this embodiment, it is possible to provide an R-T-B based sintered magnet, which has high H_{cJ} equal to or higher than that of the sintered magnet of Patent Document 1, and also has high Hₖ/H_{cJ} while suppressing a reduction in Bᵣ at low cost without using heavy rare-earth elements RH as much as possible.

The present embodiment will be described below. In the following description of this embodiment, a treatment of supplying heavy rare-earth elements RH as an RH diffusion source to a surface of an R-T-B based sintered magnet material and diffusing RH into the inside of the R-T-B based sintered magnet material, as mentioned in Patent Document 3, refers to an “RH supply and diffusion treatment”. A treatment of carrying out the RH supply and diffusion treatment, and diffusing RH into the inside of the R-T-B based sintered magnet material without supplying RH refers to an “RH diffusion treatment”. Furthermore, a heat treatment applied to an R-T-B based sintered magnet material after sintering, and a heat treatment applied after the RH supply and diffusion treatment or the RH diffusion treatment refers simply to a “heat treatment”. The R-T-B based sintered magnet before a heat treatment refers to an “R-T-B based sintered magnet material”, and the R-T-B based sintered magnet after a heat treatment refers to an “R-T-B based sintered magnet”.

### [1] Method for Producing R-T-B Based Sintered Magnet

### (1) Step of Preparing Alloy Powder

In the step of preparing an alloy powder, the composition of the alloy powder includes:

R: 27 to 35% by mass,

B: 0.9 to 1.0% by mass,

Ga: 0.15 to 0.6% by mass, and

the balance T and inevitable impurities.

In the composition, when the content of each element is less than the lower limit of the above-mentioned range, or exceeds the upper limit, it sometimes becomes impossible to obtain an R-T-B based sintered magnet having high H_{cJ} and high Hₖ/H_{cJ} while suppressing a reduction in Bᵣ. The amount of B is more preferably 0.91 to 1.0% by mass. The amount of Ga is preferably in a range of 0.2 to 0.6% by mass, more preferably 0.3 to 0.6% by mass, still more preferably 0.4 to 0.6% by mass, and most preferably 0.4 to 0.5% by mass.

R is at least one of rare-earth elements and indispensably includes Nd. Examples of the rare-earth element except for Nd include Pr. It is also possible to contain a small amount of at least one of Dy, Tb, Gd, and Ho. The content of at least one of Dy, Tb, Gd, and Ho is preferably 1.0% by mass or less based on the entire R-T-B based sintered magnet. B can be partially substituted with C. T is at least one of transition metal elements and indispensably includes Fe. Examples of the transition metal element except for Fe include Co. It is also possible to contain a small amount of V, Cr, Mn, Ni, Zr, Nb, Mo, Hf, Ta, W, and the like.

It is also possible to contain Cu and Al as the element except for the above-mentioned elements. Cu and Al may be positively added for the purpose of improving magnetic properties, and it is also possible to make use of these elements contained in raw material used, and those which are indispensably introduced in the production process of an alloy powder (raw material containing Cu and Al as impurities may be used). Each of the contents of Cu and Al (total amount in each element of the amount added positively and the amount included as inevitable impurities) is preferably 0.5% by mass or less.

In the step of preparing an alloy powder, after weighing raw materials of each element so as to adjust to the above composition, a powder is prepared by a known production method. For example, an alloy is prepared by a strip casting method, and a coarsely pulverized powder is obtained from the thus obtained alloy by a hydrogen grinding method. Alternatively, a finely pulverized powder is obtained from the coarsely pulverized powder using a jet mill. The alloy powder may be either a coarsely pulverized powder or a finely pulverized powder.

### (2) Step of Preparing Powder of Hydride of Ti

Commercially available Ti hydride powders can be employed. The grain size of commercially available Ti hydride powder is, for example, about 50 μm in terms of D50 which is a volume median value obtained by a laser diffraction method using an air flow dispersion method. A Ti hydride powder is a very stable substance as compared with a state of metal (Ti metal) and also can be pulverized by a jet mill. Therefore, there is an advantage that it is possible to handle comparatively safely even if commercially available Ti hydride powder is finely pulverized by a jet mill to give a finely pulverized powder (5 μm or less in terms of D50).

As mentioned above, in Patent Document 4, oxygen, boron, carbon, nitrogen, silicon, and the like included in a high melting point compound (an oxide, a boride, a carbide, a nitride, or a silicate of one selected from the group consisting of Al, Ga, Mg, Nb, Si, Ti, and Zr) may remain in the magnet even after sintering, thus degrading magnetic properties of the thus obtained magnet. The Ti hydride powder used in this embodiment is decomposed into Ti and H₂ (hydrogen) during the sintering step, and hydrogen is released into a sintering furnace from the magnet, and discharged finally out of the sintering furnace. Therefore, there is an advantage that magnetic properties may be scarcely degraded. Whereby, it is possible to suppress an increase in the content of oxygen, the content of carbon and the content of nitrogen of the R-T-B based sintered magnet and, for example, it is possible to produce an R-T-B based sintered magnet having oxygen content of 2,000 ppm or less, carbon content of 1,500 ppm or less, and nitrogen content of 1,000 ppm or less, thus enabling further improvement in magnetic properties.

### (3) Step of Preparing Mixed Powder

The thus prepared alloy powder and Ti hydride powder mentioned above are mixed so as to adjust the content of Ti in 100% by mass of the mixed powder after mixing to 0.3% by mass or less to give a mixed powder. When the content of Ti in 100% by mass of the mixed powder after mixing exceeds 0.3% by mass, it becomes impossible to obtain an R-T-B based sintered magnet having high H_{cJ} and high Hₖ/H_{cJ} while suppressing a reduction in Bᵣ. The mixing amount of Ti is preferably in a range of 0.05 to 0.3% by mass, more preferably 0.12 to 0.3% by mass, still more preferably 0.18 to 0.3% by mass, and most preferably 0.22 to 0.3% by mass. Mixing is preferably performed by mixing an alloy powder composed of a coarsely pulverized powder with an (unpulverized) Ti hydride powder, followed by fine pulverization using a jet mill. Fine pulverization after mixing enables uniform mixing, and preparation of a mixed powder composed of a finely pulverized powder of an alloy powder and a Ti hydride powder in the same step as usual without adding a new step. As a matter of course, an alloy powder and a Ti hydride powder are separately subjected to fine pulverization, followed by mixing using a known mixing means to prepare a mixed powder. In this case, mixing may be performed by a dry or wet method.

### (4) Step of Preparing Molded Body

The mixed powder is molded to obtain a molded body. Molding is performed by a known molding means. For example, it is possible to apply a dry molding method in which a dry alloy powder is loaded in a cavity of a mold and then molded while applying a magnetic field, or a wet molding method in which a slurry containing the alloy powder dispersed therein is injected in a cavity of a mold and then molded under a magnetic field while discharging a dispersion medium of the slurry.

### (5) Step of Preparing R-T-B Based Sintered Magnet Material

The molded body is sintered to obtain an R-T-B based sintered magnet material (sintered body). Sintering is performed by a known sintering means. It is possible to apply a method of sintering in a vacuum atmosphere or inert gas (helium, argon, etc.) atmosphere at a sintering temperature of 1,000° C. or higher and 1,180° C. or lower, for about 1 to 10 hours as a sintering time.

### (6) Step of Subjecting R-T-B Based Sintered Magnet Material to Heat Treatment

The R-T-B based sintered magnet material is subjected to a heat treatment to obtain an R-T-B based sintered magnet.

Known conditions can be applied to temperature, time, atmosphere, and the like of a heat treatment. For example, it is possible to employ conditions in which a heat treatment is performed at only a comparatively low temperature (400° C. or higher and 600° C. or lower) (single-stage heat treatment), or at a comparatively low temperature (400° C. or higher and 600° C. or lower) after a heat treatment at a comparatively elevated temperature (700° C. or higher and sintering temperature or lower (for example, 1050° C. or lower) (two-stage heat treatment). Examples of preferred conditions include conditions in which a heat treatment is applied at 730° C. or higher and 1020° C. or lower for 5 about minutes to 500 minutes and, after cooling to (cooling to room temperature, or 440° C. or higher and 550° C. or lower), a heat treat is performed at 440° C. or higher and 550° C. or lower for about 5 minutes to 500 minutes. The heat treatment is preferably performed in an atmosphere such as a vacuum atmosphere or an inert gas (helium, argon, etc.) atmosphere.

When an RH supply and diffusion treatment is applied so as to further improve H_{cJ} of the R-T-B based sintered magnet, the following step is carried out in place of applying a heat treatment to the R-T-B based sintered magnet material.

### (7) Step of Preparing RH Diffusion Source

It is possible to apply, as the step of preparing an RH diffusion source comprising a metal, an alloy, or a compound, each containing Dy and/or Tb, the step disclosed in a known RH supply and diffusion treatment such as disclosed in Patent Document 3.

### (8) Step of Subjecting to RH Supply and Diffusion Treatment

It is possible to apply, as the step of applying an RH supply and diffusion treatment of supplying Dy and/or Tb of an RH diffusion source to an R-T-B based sintered magnet material, followed by diffusion, a known RH supply and diffusion treatment such as disclosed in Patent Document 3. The RH supply and diffusion treatment may be performed by a method of diffusing heavy rare-earth elements RH from an RH diffusion source into the inside of an R-T-B based sintered magnet material while supplying to a surface thereof, like Patent Document 3, or a method of allowing metal, an alloy or a compound, each containing RH, to exist on a surface of an R-T-B based sintered magnet material in advance by film formation (dry method or wet method) or application, and diffusing the metal, alloy or compound into the inside of the R-T-B based sintered magnet material by a heat treatment.

An RH diffusion treatment may be performed for the purpose of further diffusing Dy and/or Tb, which is supplied into the inside of an R-T-B based sintered magnet material by the RH supply and diffusion treatment, into the inside. After carrying out the RH supply and diffusion treatment, heating is performed without newly supplying Dy and/or Tb from the RH diffusion source, in the RH diffusion treatment. For example, when the RH supply and diffusion treatment is carried out and then an RH diffusion treatment is performed, the RH diffusion treatment is preferably carried out at 700° C. or higher and 1,000° C. or lower, and more preferably 800° C. or higher and 950° C. or lower, under conditions that Dy and/or Tb is/are not supplied newly from the RH supply source. Alternatively, when the RH supply and diffusion treatment and then only an R-T-B based sintered magnet material is recovered, the treatment is preferably subjected to the R-T-B based sintered magnet material in a vacuum under an atmospheric pressure or less or inert gas atmosphere preferably at 700° C. or higher and 1,000° C. or lower, and more preferably at 800° C. or higher and 950° C. or lower. The treatment hour is, for example, in a range of about 10 minutes to 24 hours, and more preferably about 1 hour to 6 hours. By the RH diffusion treatment, diffusion of Dy and/or Tb occurs in the inside of the R-T-B based sintered magnet material, and Dy and/or Tb supplied in the vicinity of a surface layer is/are further diffused into the inside, thus enabling an increase in H_{cJ} of the entire magnet.

### (9) Step of Subjecting R-T-B Based Sintered Magnet Material to Heat Treatment

A heat treatment is applied to an R-T-B based sintered magnet material obtained in an RH supply and diffusion treatment step (RH diffusion step may be performed after the RH supply and diffusion treatment step) to obtain an R-T-B based sintered magnet. This heat treatment is the same as the heat treatment (6).

### [2] R-T-B Based Sintered Magnet

As mentioned above, by adding a Ti hydride powder, an R₆T₁₃M compound (typically, an Nd₆Fe₁₃Ga compound) and a boride of Ti (typically, a TiB₂ compound) are formed in sintering and/or a heat treatment (including the case of subjecting to an RH supply and diffusion treatment, and a heat treatment in place of the step of subjecting to a heat treatment). Namely, the R-T-B based sintered magnet obtained by a method for producing an R-T-B based sintered magnet of this embodiment has a structure in which an R₂T₁₄B compound, an R₆T₁₃M compound and a boride of Ti coexist.

In the R₂T₁₄B compound, R is at least one of rare-earth elements and indispensably includes Nd. Examples of the rare-earth element except for Nd include Pr. It is possible to further contain a small amount of at least one of Dy, Tb, Gd, and Ho. T is at least one of transition metal elements and indispensably includes Fe. Examples of the transition metal element except for Fe include Co. B can be partially substituted with C.

In the R₆T₁₃M compound, R is at least one of rare-earth elements and indispensably includes Nd. Examples of the rare-earth element except for Nd include Pr. It is possible to further contain a small amount of at least one of Dy, Tb, Gd, and Ho. T is at least one of transition metal elements and indispensably includes Fe. Examples of the transition metal element except for Fe include Co. M is mainly Ga. The R₆T₁₃M compound is typically an Nd₆Fe₁₃Ga compound. The R₆T₁₃M compound has a La₆Co₁₁Ga₃ type crystal structure. The R₆T₁₃M compound is sometimes an R₆T_{13-α}M_{1+α} compound (α is typically 2 or less) according to a state thereof. When using only Ga as M, the compound may be R₆T_{13-α}(Ga_{1-x-y-z}CuₓAl_{y}Si_{z})_{1+α} in case an R-T-B based sintered magnet contains Al, Cu, and Si.

In the R-T-B based sintered magnet obtained by a method for producing an R-T-B based sintered magnet of this embodiment, an R₆T₁₃M compound is included in an area ratio of 1% or more in an arbitrary cross section thereof. Furthermore, when having higher H_{cJ}, the R₆T₁₃M compound is included in an area ratio of 2% or more. It is possible to determine the area ratio of the R₆T₁₃M compound by analyzing an image of a reflected electron image (BSE image) of an arbitrary cross section of the R-T-B based sintered magnet, which is observed by a field emission-type scanning electron microscope (FE-SEM), using commercially available an image processing software, as shown in the below-mentioned Examples.

A boride of Ti is typically a TiB₂ compound. A TiB compound sometimes exists together with the TiB₂ compound. Examples of Patent Document 4 mention that, when a high melting point compound is TiC, TiC reacts with B in a material of an R-T-B-based rare-earth permanent magnet during sintering to form TiB₂, which exists on grain boundaries. However, carbon (C) separated from TiC may remain in the magnet even after sintering, thus degrading magnetic properties of the thus obtained magnet. It is considered that the R₆T₁₃M compound is scarcely formed since the content of Ga is 0.08% by mass in Examples of Patent Document 4. Therefore, it is considered that there has never been obtained an R-T-B based sintered magnet having a structure in which an R₂T₁₄B compound, an R₆T₁₃M compound, and a boride of Ti coexist, in Patent Document 4.

### EXAMPLES

### 1. Examples According to First Embodiment

### Test Example 1

Nd metal, Pr metal, ferroboron alloy, Ga metal, Cu metal, Al metal, electrolytic Co, Ti metal, and electrolytic iron (any of metals has a purity of 99% by mass or more) were mixed so as to obtain a given composition, and then these raw materials were melted and subjected to casting by a strip casting method to obtain a flaky raw alloy having a thickness of 0.2 to 0.4 mm. The flaky raw alloy thus obtained was subjected to hydrogen embrittlement in a hydrogen atmosphere under an increased pressure and then subjected to a dehydrogenation treatment of heating to 550° C. in vacuum and cooling to obtain a coarsely pulverized powder.

To the coarsely pulverized powder thus obtained, zinc stearate was added as a lubricant in the proportion of 0.04% by mass based on 100% by mass of the coarsely pulverized powder, followed by mixing. Using an air flow-type pulverizer (jet milling machine), the mixture was subjected to dry pulverization in a nitrogen gas flow to obtain a finely pulverized powder (alloy powder) having a grain size D50 of 4 μm. In this Test Example, the oxygen amount of the sintered magnet thus obtained finally was adjusted to about 0.1% by mass by adjusting the oxygen concentration in a nitrogen gas during pulverization to 50 ppm or less. The grain size D50 is the value obtained by a laser diffraction method using an air flow dispersion method (median size on a volume basis).

To the finely pulverized powder mentioned above, zinc stearate was added as a lubricant in the proportion of 0.05% by mass based on 100% by mass of the finely pulverized powder, followed by mixing. The mixture was molded under a magnetic field to obtain a molded body. A molding device used was a so-called perpendicular magnetic field molding device (transverse magnetic field molding device) in which a magnetic field application direction and a pressuring direction are perpendicular to each other.

The molded body thus obtained was sintered by retaining in vacuum at 1,070° C. to 1,090° C. for 4 hours, and then rapid cooled to obtain a sintered magnet.

The sintered magnet had a density of 7.5 Mg/m³ or more. The component analysis results of the thus obtained sintered magnet are shown in Table 1. The respective components in Table 1 were determined using high-frequency inductively coupled plasma emission spectrometry (ICP-OES). O (amount of oxygen) was measured using a gas fusion-infrared absorption method, N (amount of nitrogen) was measured using a gas fusion-thermal conductivity method, and C (amount of carbon) was measured by a combustion infrared absorption method, using a gas analyzer. The amount of R (u) in Table 1 is the value obtained by summing up the amounts of Nd and Pr, and the amount of M (j) is the value obtained by summing up the amounts of Cu, Cr, Mn, Si, 0, N, and C as elements except for R, B, Ga, Al, Co, Ti, and Fe, using ICP-OES. The same shall apply in Tables 3, 5, and 7 mentioned below. Using the values shown in Table 1, (g′+v′+z′)−(14×(w′−2×q′)) of the formula (A) and (g′+v′+z′)−(14×(w′−q′)) of the formula (B) were calculated. The columns “Formula A” and “Formula B” in Table 1 were filled with “G” (Good) when the calculated value is within the range of present invention, while the columns in Table 1 were filled with “B” (Bad) when the calculated value deviates from the range of present invention. The same shall apply to Tables 3, 5, and 7 mentioned below. As shown in Table 1, each of samples Nos. 1 to 3, 4 to 6, 7 to 9, 10 to 11, 12 to 15, and 16 to 17 has the almost same composition, except that the samples differ in the amount of B.

TABLE 1

| | Component (% by mass) | | | | | | | | | | | |
|---|---|---|---|---|---|---|---|---|---|---|---|---|
| Sample | | | R | B | Ga | Al | Co | Ti | Fe | M | | |
| No. | Nd | Pr | u | w | x | z | v | q | g | j | Cu | Cr |
| 1 | 22.5 | 7.4 | 29.9 | 0.90 | 0.52 | 0.21 | 0.90 | 0.00 | 66.7 | 0.35 | 0.09 | 0.00 |
| 2 | 22.5 | 7.4 | 29.9 | 0.91 | 0.52 | 0.21 | 0.90 | 0.00 | 66.8 | 0.35 | 0.09 | 0.00 |
| 3 | 22.5 | 7.4 | 29.9 | 0.92 | 0.52 | 0.21 | 0.90 | 0.00 | 66.8 | 0.37 | 0.09 | 0.00 |
| 4 | 23.4 | 7.7 | 31.1 | 0.90 | 0.49 | 0.10 | 0.50 | 0.10 | 65.9 | 0.56 | 0.15 | 0.01 |
| 5 | 23.4 | 7.7 | 31.1 | 0.93 | 0.49 | 0.10 | 0.50 | 0.10 | 65.9 | 0.55 | 0.15 | 0.01 |
| 6 | 23.4 | 7.7 | 31.1 | 0.95 | 0.48 | 0.10 | 0.50 | 0.10 | 66.1 | 0.54 | 0.15 | 0.01 |
| 7 | 22.6 | 7.4 | 30.0 | 0.93 | 0.49 | 0.25 | 0.90 | 0.15 | 66.4 | 0.46 | 0.10 | 0.01 |
| 8 | 22.5 | 7.4 | 29.9 | 0.94 | 0.48 | 0.25 | 0.90 | 0.15 | 66.5 | 0.47 | 0.10 | 0.01 |
| 9 | 22.5 | 7.4 | 29.9 | 0.95 | 0.48 | 0.26 | 0.90 | 0.15 | 66.5 | 0.47 | 0.10 | 0.01 |
| 10 | 22.7 | 7.3 | 30.0 | 0.93 | 0.48 | 0.25 | 0.91 | 0.18 | 66.4 | 0.47 | 0.09 | 0.01 |
| 11 | 22.8 | 7.3 | 30.1 | 0.95 | 0.47 | 0.25 | 0.90 | 0.18 | 66.3 | 0.48 | 0.10 | 0.01 |
| 12 | 22.8 | 7.4 | 30.2 | 0.95 | 0.48 | 0.24 | 0.90 | 0.23 | 66.0 | 0.47 | 0.09 | 0.01 |
| 13 | 22.8 | 7.3 | 30.1 | 0.97 | 0.47 | 0.24 | 0.91 | 0.23 | 66.2 | 0.46 | 0.08 | 0.02 |
| 14 | 22.7 | 7.3 | 30.0 | 0.98 | 0.47 | 0.25 | 0.91 | 0.23 | 66.3 | 0.45 | 0.08 | 0.01 |
| 15 | 22.7 | 7.3 | 30.0 | 0.99 | 0.47 | 0.24 | 0.91 | 0.23 | 66.3 | 0.46 | 0.08 | 0.01 |
| 16 | 22.6 | 7.4 | 30.0 | 0.94 | 0.47 | 0.24 | 0.90 | 0.25 | 66.4 | 0.47 | 0.09 | 0.01 |
| 17 | 22.6 | 7.4 | 30.0 | 0.99 | 0.47 | 0.25 | 0.90 | 0.25 | 66.3 | 0.47 | 0.10 | 0.01 |

| Sample | Component (% by mass) | | | | | Formula A | Formula B | |
|---|---|---|---|---|---|---|---|---|
| No. | Mn | Si | O | N | C | 0.06≦ | 0.10≧ | Note |
| 1 | 0.03 | 0.01 | 0.09 | 0.05 | 0.08 | B | G | Comparative |
| | | | | | | | | Example |
| 2 | 0.03 | 0.01 | 0.09 | 0.06 | 0.07 | B | G | Comparative |
| | | | | | | | | Example |
| 3 | 0.03 | 0.01 | 0.11 | 0.06 | 0.08 | B | G | Comparative |
| | | | | | | | | Example |
| 4 | 0.04 | 0.12 | 0.11 | 0.04 | 0.09 | G | G | Comparative |
| | | | | | | | | Example |
| 5 | 0.04 | 0.12 | 0.10 | 0.05 | 0.08 | B | G | Comparative |
| | | | | | | | | Example |
| 6 | 0.04 | 0.12 | 0.10 | 0.04 | 0.08 | B | G | Comparative |
| | | | | | | | | Example |
| 7 | 0.04 | 0.09 | 0.10 | 0.05 | 0.07 | G | G | Example |
| 8 | 0.04 | 0.10 | 0.09 | 0.05 | 0.08 | G | G | Example |
| 9 | 0.04 | 0.09 | 0.10 | 0.05 | 0.08 | G | G | Example |
| 10 | 0.04 | 0.09 | 0.12 | 0.04 | 0.08 | G | G | Example |
| 11 | 0.04 | 0.10 | 0.10 | 0.05 | 0.08 | G | G | Example |
| 12 | 0.04 | 0.09 | 0.11 | 0.04 | 0.09 | G | G | Example |
| 13 | 0.04 | 0.09 | 0.10 | 0.05 | 0.08 | G | G | Example |
| 14 | 0.04 | 0.10 | 0.10 | 0.04 | 0.08 | G | G | Example |
| 15 | 0.04 | 0.10 | 0.11 | 0.05 | 0.08 | G | G | Example |
| 16 | 0.04 | 0.10 | 0.10 | 0.05 | 0.06 | G | G | Example |
| 17 | 0.04 | 0.10 | 0.09 | 0.05 | 0.06 | G | G | Example |

The sintered magnet thus obtained was subjected to a heat treatment of retaining at 900 to 1,000° C. for 2 hours and cooling to room temperature, followed by retaining at 500° C. for 2 hours and cooling to room temperature. The sintered magnet thus obtained after the heat treatment was machined to produce samples of 7 mm in length×7 mm in width×7 mm in thickness, magnetized under a pulse magnetic field of 3.2 MA/m, and then Bᵣ and H_{cJ} of each sample were measured by a B-H tracer. The measurements results are shown in Table 2. Component analysis and gas analysis of each R-T-B based sintered magnet subjected to the measurement of Bᵣ and H_{cJ} were performed. The results were the same as those of component analysis and gas analysis of the R-T-B based sintered magnet material in Table 1.

Furthermore, a change in H_{cJ} to a change in the amount of B in each of samples Nos. 1 to 3, 4 to 6, 7 to 9, 10 to 11, 12 to 15, and 16 to 17 was determined in the following manner.

First, a difference in the amount of B between the lowest amount of B and the highest amount of B among the respective samples (among the almost same compositions except for the amount of B) was determined, and a difference between the lowest H_{cJ} and the highest H_{cJ} was determined, and then the difference in H_{cJ} was divided by the difference in the amount of B, thus determining how much does H_{cJ} change when the amount of B changes by 0.01% by mass. For example, the change in H_{cJ} in samples Nos. 4 to 6 was determined in the following manner.

First, in samples Nos. 4 to 6, the lowest amount of B is 0.90% by mass of sample No. 4, the highest the amount of B is 0.95% by mass of sample No. 6, the lowest H_{cJ} is 1,278 kA/m of sample No. 6, and the highest H_{cJ} is 1,509 kA/m of sample No. 4. When the amount of B changes from 0.90% by mass to 0.95% by mass (changes by 0.05% by mass), H_{cJ} changes from 1,508 kA/m to 1,278 kA/m (changes by 230 kA/m), so that, when the amount of B changes by 0.01% by mass, H_{cJ} changes by 46 kA/m (230/(0.05≦x≦100)). In the same manner, the change in H_{cJ} to the change in the amount of B in samples Nos. 1 to 3, 7 to 9, 10 to 11, 12 to 15, and 16 to 17 was also determined. The results are shown in the column “ΔH_{cJ}/0.01B” in Table 2. ΔH_{cJ}/0.01B in Table 6 mentioned below was determined in the same manner.

TABLE 2

| | B | Ti | | | ΔH_{cJ}/ | |
|---|---|---|---|---|---|---|
| Sample | (Atom- | (Atom- | Br | H_{cJ} | 0.01B | |
| No. | ic %) | ic %) | (T) | (kA/m) | (kA/m) | Note |
| 1 | 0.90 | 0.00 | 1.39 | 1,458 | 99 | Comparative |
| | | | | | | Example |
| 2 | 0.91 | 0.00 | 1.40 | 1,372 | | Comparative |
| | | | | | | Example |
| 3 | 0.92 | 0.00 | 1.41 | 1,260 | | Comparative |
| | | | | | | Example |
| 4 | 0.90 | 0.10 | 1.37 | 1,508 | 46 | Comparative |
| | | | | | | Example |
| 5 | 0.93 | 0.10 | 1.38 | 1,372 | | Comparative |
| | | | | | | Example |
| 6 | 0.95 | 0.10 | 1.38 | 1,278 | | Comparative |
| | | | | | | Example |
| 7 | 0.93 | 0.15 | 1.37 | 1,413 | 24 | Example |
| 8 | 0.94 | 0.15 | 1.38 | 1,461 | | Example |
| 9 | 0.95 | 0.15 | 1.38 | 1,444 | | Example |
| 10 | 0.93 | 0.18 | 1.37 | 1,405 | 12 | Example |
| 11 | 0.95 | 0.18 | 1.38 | 1,428 | | Example |
| 12 | 0.95 | 0.23 | 1.38 | 1,400 | 11 | Example |
| 13 | 0.97 | 0.23 | 1.38 | 1,445 | | Example |
| 14 | 0.98 | 0.23 | 1.38 | 1,445 | | Example |
| 15 | 0.99 | 0.23 | 1.39 | 1,434 | | Example |
| 16 | 0.94 | 0.25 | 1.34 | 1,460 | 7 | Example |
| 17 | 0.99 | 0.25 | 1.37 | 1,425 | | Example |

As shown in Table 2, samples Nos. 7 to 9, 10 to 11, 12 to 15, and 16 to 17, which are samples of Examples according to this embodiment, exhibit ΔH_{cJ}/0.01B of 24 kA/m or less, namely, small change in H_{cJ} to the change in the amount of B, and also exhibit high Bᵣ and high H_{cJ}. Meanwhile, samples Nos. 1 to 3, and 4 to 6 in which the amount of Ti deviates from the range of this embodiment exhibit ΔH_{cJ}/0.01B B of 46 kA/m or more, namely, the change in H_{cJ} to the change in the amount of B is larger than that of samples of Examples. Therefore, when the amount of B increases, H_{cJ} decreases (for example, 1,260 kA/m in sample No. 3), thus failing to obtain high H_{cJ}. As is apparent from samples Nos. 10 to 11, 12 to 15, and 16 to 17 which are samples of Examples according to this embodiment, when the amount of Ti is 0.18% by mass or more, ΔH_{cJ}/0.01B is 12 kA/m or less, namely, the change in H_{cJ} to the change in the amount of B is small further.

### Test Example 2

Nd metal, Pr metal, ferroboron alloy, Ga metal, Cu metal, Al metal, electrolytic Co, Ti metal, and electrolytic iron (any of metals has a purity of 99% by mass or more) were mixed so as to obtain a given composition, and then these raw materials were melted and subjected to casting by a strip casting method to obtain a flaky raw alloy having a thickness of 0.2 to 0.4 mm. Using the flaky raw alloy thus obtained, a coarsely pulverized powder was prepared in the same manner as in Test Example 1. The coarsely pulverized powder thus obtained was subjected to dry pulverization in the same manner as in Test Example 1 to obtain a finely pulverized powder (alloy powder) having a grain size D50 of 4 μm. In the same manner as in Test Example 1, the mixture was molded under a magnetic field to obtain a molded body. The molded body thus obtained was sintered by retaining in vacuum at 1,080° C. for 4 hours, and then rapid cooled to obtain a sintered magnet. The sintered magnet had a density of 7.5 Mg/m³ or more.

The component analysis results of the sintered magnet thus obtained are shown in Table 3. The respective components in Table 3 were determined using high-frequency inductively coupled plasma emission spectrometry (ICP-OES). O (amount of oxygen) was measured by a gas fusion-infrared absorption method, N (amount of nitrogen) was measured by a gas fusion-thermal conductivity method, and C (amount of carbon) was measured by a combustion infrared absorption method, using a gas analyzer. The results of the formula (A) and the formula (B) calculated from analytical values of ICP-OES are shown in Table 3. The sintered magnet thus obtained was subjected to the same heat treatment as in Test Example 1. The sintered magnet thus obtained after the heat treatment was machined to produce samples of 7 mm in length×7 mm in width×7 mm in thickness, magnetized under a pulse magnetic field of 3.2 MA/m, and then Bᵣ and H_{cJ} of each sample were measured by a B-H tracer. The measurements results are shown in Table 4. Component analysis and gas analysis of each R-T-B based sintered magnet subjected to the measurement of Bᵣ and H_{cJ} were performed. The results were the same as those of component analysis and gas analysis of the R-T-B based sintered magnet material in Table 3. The measurement results are shown in Table 4.

TABLE 3

| | Component (% by mass) | | | | | | | | | | | |
|---|---|---|---|---|---|---|---|---|---|---|---|---|
| Sample | | | R | B | Ga | Al | Co | Ti | Fe | M | | |
| No. | Nd | Pr | u | w | x | z | v | q | g | j | Cu | Cr |
| 18 | 22.6 | 7.4 | 30.0 | 0.96 | 0.48 | 0.26 | 0.90 | 0.15 | 66.2 | 0.51 | 0.11 | 0.02 |

| Sample | Component (% by mass) | | | | | Formula A | Formula B | |
|---|---|---|---|---|---|---|---|---|
| No. | Mn | Si | O | N | C | 0.06≦ | 0.10≧ | Note |
| 18 | 0.04 | 0.10 | 0.11 | 0.05 | 0.08 | B | A | Comparative |
| | | | | | | | | Example |

TABLE 4

| | B | Ti | Br | H_{cJ} | |
|---|---|---|---|---|---|
| Sample No. | (% by mass) | (% by mass) | (T) | (kA/m) | Note |
| 18 | 0.96 | 0.15 | 1.41 | 1,341 | Comparative |
| | | | | | Example |

Sample No. 18 shown in Table 3 has almost the same composition as that of sample No. 9, which is sample of Example shown in Test Example 1, except that the formula (A) is not satisfied. As shown in Table 4H_{cJ} is significantly decreased to 1,341 KA/m as compared with 1,444 kA/m of sample No. 9 when the relationship between Ti and B deviates from the range of the present invention even if the amount of Ti is within the range of the present invention.

### Test Example 3

Nd metal, Pr metal, ferroboron alloy, Ga metal, Cu metal, Al metal, electrolytic Co, and electrolytic iron (any of metals has a purity of 99% by mass or more) were mixed so as to obtain a given composition, and then these raw materials were melted and subjected to casting by a strip casting method to obtain a flaky raw alloy having a thickness of 0.2 to 0.4 mm. The flaky raw alloy thus obtained was subjected to hydrogen embrittlement in a hydrogen atmosphere under an increased pressure and then subjected to a dehydrogenation treatment of heating to 550° C. in vacuum and cooling to obtain a coarsely pulverized powder. To the coarsely pulverized powder thus obtained, zinc stearate was added as a lubricant in the proportion of 0.04% by mass based on 100% by mass of the coarsely pulverized powder, followed by mixing. Using an air flow-type pulverizer (jet milling machine), the mixture was subjected to dry pulverization in a nitrogen gas flow to obtain a finely pulverized powder (alloy powder) having a grain size D50 of 4 μm. In this Test Example, the oxygen amount of the sintered magnet thus obtained finally was adjusted to about 0.1% by mass by adjusting the oxygen concentration in a nitrogen gas during pulverization to 50 ppm or less. The grain size D50 is the value obtained by a laser diffraction method using an air flow dispersion method (median size on a volume basis).

To the finely pulverized powder mentioned above, 0.22% by mass of a TiH₂ powder having a grain size D50 of 10 μm or less was added and zinc stearate was added as a lubricant in the proportion of 0.05% by mass based on 100% by mass of the finely pulverized powder, followed by mixing. The mixture was molded under a magnetic field to obtain a molded body. A molding device used was a so-called perpendicular magnetic field molding device (transverse magnetic field molding device) in which a magnetic field application direction and a pressuring direction are perpendicular to each other.

The molded body thus obtained was sintered by retaining in vacuum at 1,040° C. for 4 hours, and then rapid cooled to obtain a sintered magnet.

The sintered magnet had a density of 7.5 Mg/m³ or more. The component analysis results of the thus obtained sintered magnet are shown in Table 5. The respective components in Table 5 were determined using high-frequency inductively coupled plasma emission spectrometry (ICP-OES). O (amount of oxygen) was measured using a gas fusion-infrared absorption method, N (amount of nitrogen) was measured using a gas fusion-thermal conductivity method, and C (amount of carbon) was measured by a combustion infrared absorption method, using a gas analyzer. The results of the formula (A) and the formula (B) calculated from analytical values of ICP-OES are shown in Table 5. As shown in Table 5, each of samples Nos. 19 to 22 has almost the same composition, except that the samples differ in the amount of B.

TABLE 5

| | Component (% by mass) | | | | | | | | | | | |
|---|---|---|---|---|---|---|---|---|---|---|---|---|
| Sample | | | R | B | Ga | Al | Co | Ti | Fe | M | | |
| No. | Nd | Pr | u | w | x | z | v | q | g | j | Cu | Cr |
| 19 | 22.5 | 7.4 | 29.9 | 0.93 | 0.50 | 0.22 | 0.89 | 0.21 | 66.9 | 0.36 | 0.09 | 0.01 |
| 20 | 22.5 | 7.4 | 29.9 | 0.94 | 0.51 | 0.22 | 0.89 | 0.21 | 66.8 | 0.36 | 0.09 | 0.01 |
| 21 | 22.5 | 7.4 | 29.8 | 0.96 | 0.50 | 0.21 | 0.89 | 0.21 | 67.0 | 0.34 | 0.09 | 0.01 |
| 22 | 22.5 | 7.4 | 29.9 | 0.97 | 0.50 | 0.21 | 0.90 | 0.21 | 66.9 | 0.35 | 0.09 | 0.01 |

| Sample | Component (% by mass) | | | | | Formula A | Formula B | |
|---|---|---|---|---|---|---|---|---|
| No. | Mn | Si | O | N | C | 0.06≦ | 0.10≧ | Note |
| 19 | 0.03 | 0.02 | 0.09 | 0.05 | 0.07 | G | G | Example |
| 20 | 0.03 | 0.02 | 0.09 | 0.05 | 0.07 | G | G | Example |
| 21 | 0.03 | 0.02 | 0.08 | 0.04 | 0.07 | G | G | Example |
| 22 | 0.03 | 0.02 | 0.08 | 0.05 | 0.07 | G | G | Example |

The sintered magnet thus obtained was subjected to a heat treatment of retaining at 900 to 1,000° C. for 2 hours and cooling to room temperature, followed by retaining at 500° C. for 2 hours and cooling to room temperature. The sintered magnet thus obtained after the heat treatment was machined to produce samples of 7 mm in length×7 mm in width×7 mm in thickness and magnetized under a pulse magnetic field of 3.2 MA/m, and then Bᵣ and H_{cJ} of each sample were measured by a B-H tracer. The measurements results are shown in Table 6. Component analysis and gas analysis of each R-T-B based sintered magnet subjected to the measurement of Bᵣ and H_{cJ} were performed. The results were the same as those of component analysis and gas analysis of the R-T-B based sintered magnet material in Table 5. Furthermore, the change in H_{cJ} to the change in the amount of B in samples Nos. 19 to 22 is shown in ΔH_{cJ}/0.01B of Table 6.

TABLE 6

| | B | Ti | | | ΔH_{cJ}/ | |
|---|---|---|---|---|---|---|
| Sample | (% by | (% by | Bᵣ | H_{cJ} | 0.01B | |
| No. | mass) | mass) | (T) | (kA/m) | (kA/m) | Note |
| 19 | 0.93 | 0.21 | 1.38 | 1,391 | 6 | Example |
| 20 | 0.94 | 0.21 | 1.39 | 1,405 | | Example |
| 21 | 0.96 | 0.21 | 1.39 | 1,415 | | Example |
| 22 | 0.97 | 0.21 | 1.39 | 1,393 | | Example |

As shown in Table 6, sample of Example according to this embodiment exhibits small change in ΔH_{cJ}/0.01B of 6 kA/m, and also has high Bᵣ and high H_{cJ}.

### Test Example 4

Nd metal, Pr metal, ferroboron alloy, Ga metal, Cu metal, Al metal, electrolytic Co, and electrolytic iron (any of metals has a purity of 99% by mass or more) were mixed so as to obtain a given composition, and then these raw materials were melted and subjected to casting by a strip casting method to obtain a flaky raw alloy having a thickness of 0.2 to 0.4 mm. The flaky raw alloy thus obtained was subjected to hydrogen embrittlement in a hydrogen atmosphere under an increased pressure and then subjected to a dehydrogenation treatment of heating to 550° C. in vacuum and cooling to obtain a coarsely pulverized powder. To the coarsely pulverized powder thus obtained, zinc stearate was added as a lubricant in the proportion of 0.04% by mass based on 100% by mass of the coarsely pulverized powder, followed by mixing. Using an air flow-type pulverizer (jet milling machine), the mixture was subjected to dry pulverization in a nitrogen gas flow to obtain a finely pulverized powder (alloy powder) having a grain size D50 of 4 μm. In this Test Example, the oxygen amount of the sintered magnet thus obtained finally was adjusted to about 0.1% by mass by adjusting the oxygen concentration in a nitrogen gas during pulverization to 50 ppm or less. The grain size D50 is the value obtained by a laser diffraction method using an air flow dispersion method (median size on a volume basis).

To the finely pulverized powder mentioned above, 0.1 to 0.28% by mass of a TiH₂ powder having a grain size D50 of 10 μm or less was added and zinc stearate was added as a lubricant in the proportion of 0.05% by mass based on 100% by mass of the finely pulverized powder, followed by mixing. The mixture was molded under a magnetic field to obtain a molded body. A molding device used was a so-called perpendicular magnetic field molding device (transverse magnetic field molding device) in which a magnetic field application direction and a pressuring direction are perpendicular to each other.

The molded body thus obtained was sintered by retaining in vacuum at 1,040° C. for 4 hours, and then rapid cooled to obtain a sintered magnet.

The sintered magnet had a density of 7.5 Mg/m³ or more. The results of component analysis and gas analysis ((O (amount of oxygen), N (amount of nitrogen), and C (amount of carbon)) of the thus obtained sintered magnet are shown in Table 7. The respective components in Table 7 were determined using high-frequency inductively coupled plasma emission spectrometry (ICP-OES). O (amount of oxygen) was measured using a gas fusion-infrared absorption method, N (amount of nitrogen) was measured using a gas fusion-thermal conductivity method, and C (amount of carbon) was measured by a combustion infrared absorption method, using a gas analyzer. The results of the formula (A) and the formula (B) calculated from analytical values of ICP-OES are shown in Table 7. As shown in Table 7, samples Nos. 23 to 26 and 27 to 28 have almost the same composition, except that the samples differ in the amount of Ti.

TABLE 7

| | Component (% by mass) | | | | | | | | | | | |
|---|---|---|---|---|---|---|---|---|---|---|---|---|
| Sample | | | R | B | Ga | Al | Co | Ti | Fe | M | | |
| No. | Nd | Pr | u | w | x | z | v | q | g | j | Cu | Cr |
| 23 | 23.3 | 7.5 | 30.8 | 0.94 | 0.50 | 0.32 | 0.48 | 0.00 | 65.6 | 0.44 | 0.14 | 0.02 |
| 24 | 23.3 | 7.5 | 30.8 | 0.94 | 0.51 | 0.32 | 0.48 | 0.10 | 65.7 | 0.42 | 0.15 | 0.01 |
| 25 | 23.3 | 7.6 | 30.9 | 0.94 | 0.51 | 0.32 | 0.49 | 0.19 | 65.7 | 0.43 | 0.15 | 0.02 |
| 26 | 23.3 | 7.5 | 30.8 | 0.94 | 0.50 | 0.32 | 0.49 | 0.28 | 65.7 | 0.42 | 0.14 | 0.01 |
| 27 | 21.8 | 7.3 | 29.0 | 0.93 | 0.50 | 0.31 | 0.51 | 0.25 | 67.7 | 0.39 | 0.10 | 0.01 |
| 28 | 21.8 | 7.3 | 29.0 | 0.93 | 0.51 | 0.32 | 0.50 | 0.28 | 67.8 | 0.38 | 0.10 | 0.01 |

| Sample | Component (% by mass) | | | | | Formula A | Formula B | |
|---|---|---|---|---|---|---|---|---|
| No. | Mn | Si | O | N | C | 0.06≦ | 0.10≧ | Note |
| 23 | 0.03 | 0.01 | 0.13 | 0.04 | 0.08 | B | G | Comparative |
| | | | | | | | | Example |
| 24 | 0.03 | 0.01 | 0.09 | 0.05 | 0.08 | B | G | Comparative |
| | | | | | | | | Example |
| 25 | 0.03 | 0.01 | 0.10 | 0.04 | 0.08 | G | G | Example |
| 26 | 0.03 | 0.01 | 0.11 | 0.05 | 0.07 | G | G | Example |
| 27 | 0.04 | 0.01 | 0.10 | 0.05 | 0.08 | G | G | Example |
| 28 | 0.04 | 0.01 | 0.09 | 0.05 | 0.08 | G | B | Comparative |
| | | | | | | | | Example |

The sintered magnet thus obtained was subjected to a heat treatment of retaining at 900 to 1,000° C. for 2 hours and cooling to room temperature, followed by retaining at 500° C. for 2 hours and cooling to room temperature. The sintered magnet thus obtained after the heat treatment was machined to produce samples of 7 mm in length×7 mm in width×7 mm in thickness and magnetized under a pulse magnetic field of 3.2 MA/m, and then Bᵣ and H_{cJ} of each sample were measured by a B-H tracer. The measurements results are shown in Table 8. Component analysis and gas analysis of each R-T-B based sintered magnet subjected to the measurement of Bᵣ and H_{cJ} were performed. The results were the same as those of component analysis and gas analysis of the R-T-B based sintered magnet material in Table 7. The measurement results are shown in Table 8.

TABLE 8

| | B | Ti | Bᵣ | H_{cJ} | |
|---|---|---|---|---|---|
| Sample No. | (% by mass) | (% by mass) | (T) | (kA/m) | Note |
| 23 | 0.94 | 0.00 | 1.38 | 1,283 | Comparative |
| | | | | | Example |
| 24 | 0.94 | 0.10 | 1.38 | 1,352 | Comparative |
| | | | | | Example |
| 25 | 0.94 | 0.19 | 1.36 | 1,539 | Example |
| 26 | 0.94 | 0.28 | 1.33 | 1,420 | Example |
| 27 | 0.93 | 0.25 | 1.37 | 1,404 | Example |
| 28 | 0.93 | 0.28 | 1.34 | 1,286 | Comparative |
| | | | | | Example |

As shown in Table 8, samples of Comparative Examples, which do not satisfy either the formula (A) or the formula (B), exhibit H_{cJ} decreased significantly as compared with samples of Examples satisfying both formulas.

### Test Example 5

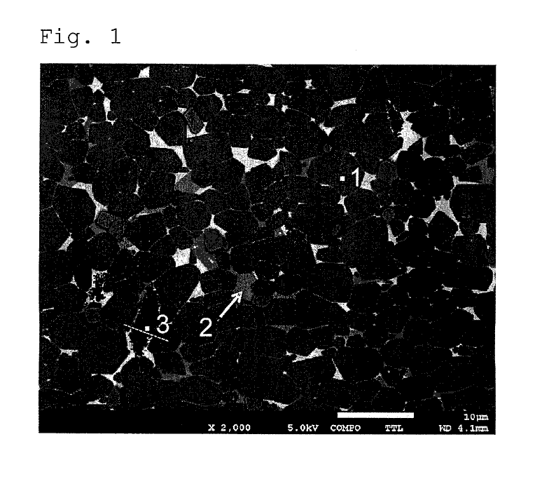

Regarding sample No. 25 (Example), after cutting using a cross section polisher (device name: SM-09010, manufactured by JEOL, Ltd.), a reflected electron image of a cut cross section was obtained using FE-SEM (device name: JSM-7001F, manufactured by JEOL, Ltd.) at a magnification of 2,000 times is shown in FIG. 1. The results of composition analysis obtained by EDX (device name: JED-2300, manufactured by JEOL, Ltd.) attached to FE-SEM are shown in Table 9. The measurement was performed excluding B since a light element has poor quantitativity in EDX.

TABLE 9
(Atomic %)

| Analytical | | | | | | | | | | | |
|---|---|---|---|---|---|---|---|---|---|---|---|
| position | Fe | Nd | Pr | Co | Cu | Ga | Al | Si | Ti | O | Note |
| 1 | 85.0 | 10.3 | 3.2 | 0.4 | — | — | 1.0 | 0.1 | — | — | R₂T₁₄B phase |
| 2 | 59.6 | 20.8 | 9.6 | — | — | 4.8 | 2.5 | 0.2 | — | 2.6 | R—T—Ga phase |
| 3 | 2.9 | 2.1 | — | — | — | — | — | — | 94.9 | — | Ti—B phase |

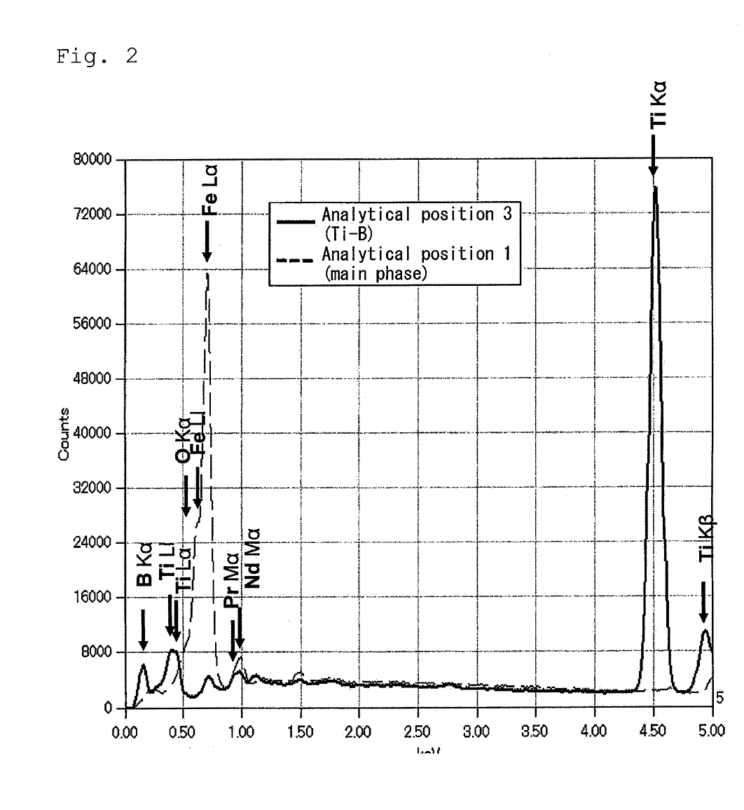

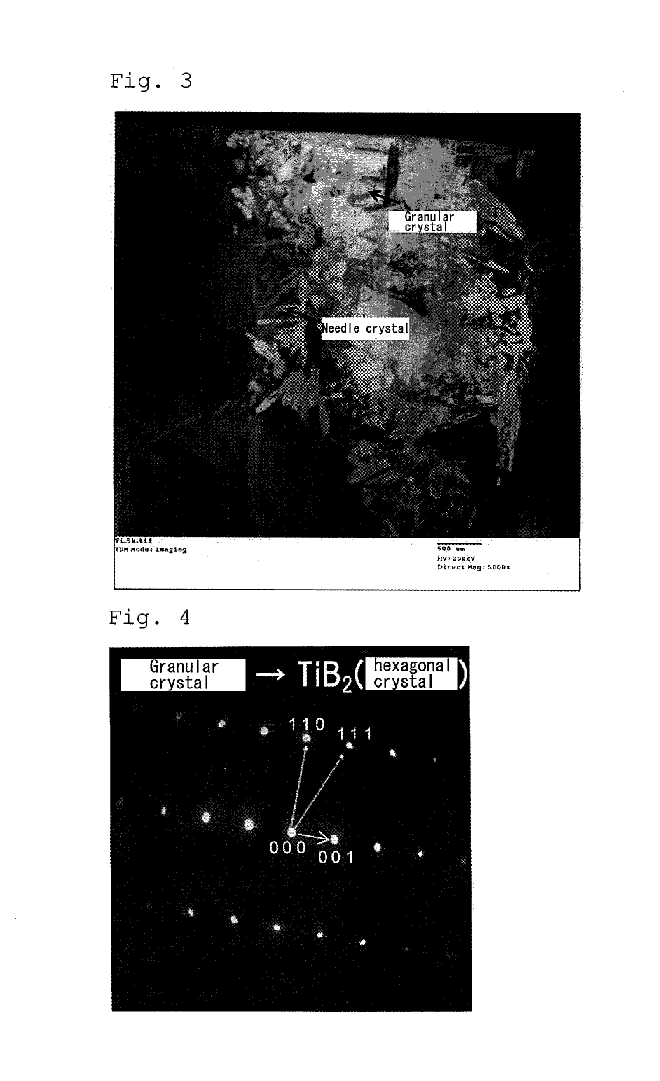

As shown in FIG. 1 and Table 9, an analytical position 1 (corresponding to 1 of FIG. 1) is an R₂T₁₄B phase as a main phase, and an analytical position 2 (corresponding to 2 of FIG. 1) having a right contrast as compared with the R₂T₁₄B phase is an R-T-Ga phase (R₆T₁₃A compound) (phase including: R: 20 atomic % or more and 35 atomic % or less, T: 55 atomic % or more and 75 atomic % or less, and Ga: 3 atomic % or more and 15 atomic % or less). At an analytical position 3 (corresponding to 3 of FIG. 1) having a dark contrast as compared with the R₂T₁₄B phase, 90% or more of Ti is detected. As mentioned above, since B is excluded because of having no quantitativity, it is impossible to judge as a Ti—B phase. Therefore, spectral data of EDX at the analytical position 3 are shown in FIG. 2. Only peaks of Ti and B are detected from spectral data and it is possible to confirm that the analytical position 3 is composed of Ti and B. Using FIB (device name: FB2100, FB2000A, manufactured by Hitachi High-Technologies Corporation.), the analytical position 3 is extracted at a position of a dotted line in a depth direction of FIG. 1 and observed using FE-TEM (device name: HF-2100 manufactured by Hitachi High-Technologies Corporation.). The results are shown in FIG. 3. As shown in FIG. 3, it was possible to confirm two kinds of crystal phases each having a different aspect ratio in the Ti—B phase. Here, a crystal having a small aspect ratio is referred to as a “granular crystal”, and a crystal having a large aspect ratio is referred to as a “needle crystal”. These crystals were subjected to analysis of a crystal structure by electron diffraction. The results are shown in FIG. 4 (granular crystal) and FIG. 5 (needle crystal). The analysis results of the granular crystal shown in FIG. 4 reveal that the granular crystal is a TiB₂ phase (hexagonal crystal). The analysis results of the needle crystal shown in FIG. 5 reveal that the needle crystal is a TiB phase (orthorhombic crystal).

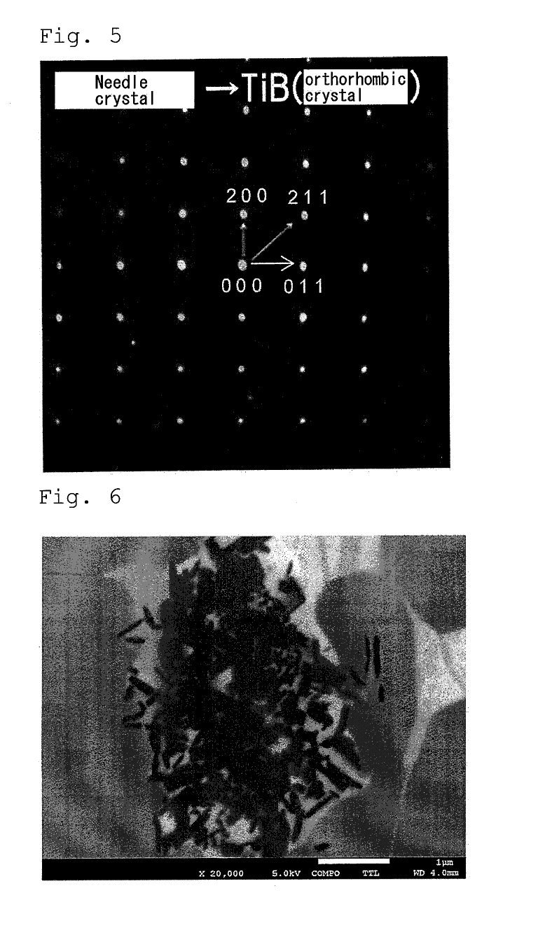

Furthermore, regarding sample No. 20 and sample No. 21, each having almost the same composition, except that the samples differ in the amount of B, after cutting using a cross section polisher (device name: SM-09010, manufactured by JEOL, Ltd.), a reflected electron image of a cut cross section was obtained using FE-SEM (device name: JSM-7001F, manufactured by JEOL, Ltd.) at a magnification of 20,000 times is shown in FIG. 6 (sample No. 20) and FIG. 7 (sample No. 21). In sample No. 20 shown in FIG. 6 in which the amount of B is small as 0.94% by mass, numerous needle crystals (TiB phase) were observed as the Ti—B phase. In sample No. 21 shown in FIG. 7 in which the amount of B is large as 0.96% by mass, numerous granular crystals (TiB₂ phase) were observed as the Ti—B phase. From these results, it is considered that the change in the amount of B (the amount of B which is not bonded to Ti) which is insufficient to the stoichiometric ratio of the R₂T₁₄B type compound decreases by changing the proportion of the TiB phase and the TiB₂ phase to be formed even if the amount of B changes, thus enabling suppressing of the change in H_{cJ} to the change in the amount of B.

### Test Example 6

Arbitrary cross sections of the R-T-B based sintered magnet of samples Nos. 13 and 15 of Table 1 and samples Nos. 20, 21, and 25 of Table 3 (all samples are samples of Examples of this embodiment) were subjected to mirror polishing, and then the mirror surfaces thereof were partially subjected to ion beam processing by a cross section polisher (SM-09010, manufactured by JEOL. Ltd.). Next, the polished surfaces thereof were observed (accelerating voltage: 5 kV, working distance: 4 mm, TTL mode, magnification: 2,000 times) by a field emission-type scanning electron microscope (FE-SEM) (JSM-7001F, manufactured by JEOL. Ltd.). The reflected electron images (BSE image) by FE-SEM were analyzed using image processing software (Scandium, manufactured by OLYMPUS SOFT IMAGING SOLUTIONS GMBH), and an area ratio of the t₆T₁₃A compound (typically Nd₆Fe₁₃Ga compound) was determined. The BSE image by FE-SEM is displayed more rightly as a mean atomic number of elements constituting the region increases, while the BSE image is displayed more darkly as a mean atomic number of elements constituting the region decreases. For example, a grain boundary phase (rare-earth-rich phase) is lightly displayed, while the main phase (R₂T₁₄B phase) and oxide are darkly displayed. The R₆T₁₃A compound is displayed with intermediate brightness. Regarding analysis by the image processing software, after making a graph in which the horizontal axis shows brightness of the BSE image and the vertical axis shows frequency (area) by image processing, the R₆T₁₃A compound was searched by energy dispersive X-ray spectrometry (EDS) and an area ratio of the R₆T₁₃A compound was determined by correspondence to specific brightness in the graph. Wideness of the visual field of a reflected electron image (BSE image) by FE-SEM was 45 μm×60 μm. The results are shown in Table 10.

TABLE 10

| | Area ratio of R₆T₁₃A | |
|---|---|---|
| Sample No. | (%) | Note |
| 13 | 2.7 | Example |
| 15 | 2.1 | Example |
| 20 | 3.2 | Example |
| 21 | 2.3 | Example |
| 25 | 3.0 | Example |

As shown in Table 10, in the R-T-B based sintered magnet of this embodiment, the R₆T₁₃A compound is included in the arbitrary cross section in an area ratio of 2% or more.

### Test Example 7

Nd metal, Pr metal, Dy metal, ferroboron alloy, Ga metal, Cu metal, Al metal, electrolytic Co, Ti metal, and electrolytic iron (any of metals has a purity of 99% by mass or more) were mixed so as to obtain a given composition shown in Table 11, and then these raw materials were melted and subjected to casting by a strip casting method to obtain a flaky raw alloy having a thickness of 0.2 to 0.4 mm. The flaky raw alloy thus obtained was subjected to hydrogen embrittlement in a hydrogen atmosphere under an increased pressure and then subjected to a dehydrogenation treatment of heating to 550° C. in vacuum and cooling to obtain a coarsely pulverized powder.

To the coarsely pulverized powder thus obtained, zinc stearate was added as a lubricant in the proportion of 0.04% by mass based on 100% by mass of the coarsely pulverized powder, followed by mixing. Using an air flow-type pulverizer (jet milling machine), the mixture was subjected to dry pulverization in a nitrogen gas flow to obtain a finely pulverized powder (alloy powder) having a grain size D50 of 4 μm. In this Test Example, the oxygen amount of the sintered magnet thus obtained finally was adjusted to about 0.1% by mass by adjusting the oxygen concentration in a nitrogen gas during pulverization to 50 ppm or less. The grain size D50 is the value obtained by a laser diffraction method using an air flow dispersion method (median size on a volume basis).

To the finely pulverized powder mentioned above, zinc stearate was added as a lubricant in the proportion of 0.05% by mass based on 100% by mass of the finely pulverized powder, followed by mixing. The mixture was molded under a magnetic field to obtain a molded body. A molding device used was a so-called perpendicular magnetic field molding device (transverse magnetic field molding device) in which a magnetic field application direction and a pressuring direction are perpendicular to each other.

The molded body thus obtained was sintered by retaining in vacuum at 1,090° C. to 1,110° C. for 4 hours, and then rapid cooled to obtain a sintered magnet.

The sintered magnet had a density of 7.6 Mg/m³ or more. The component analysis results of the thus obtained sintered magnet are shown in Table 11. The respective components in Table 11 were determined using high-frequency inductively coupled plasma emission spectrometry (ICP-OES). O (amount of oxygen) was measured using a gas fusion-infrared absorption method, N (amount of nitrogen) was measured using a gas fusion-thermal conductivity method, and C (amount of carbon) was measured by a combustion infrared absorption method, using a gas analyzer. The amount of R (u) in Table 11 is the value obtained by summing up the amounts of Nd, Pr, and Dy, and the amount of M (j) is the value obtained by summing up the amounts of Cu, Cr, Mn, Si, 0, N, and C as elements except for R, B, Ga, Al, Co, Ti, and Fe, using ICP-OES. The values (g′, v′, z′, w′, and q′) obtained by dividing each of the analytical values of Fe(g), Co(v), Al(z), B(w), and Ti(q) by the atomic weight of Fe, Co, Al, B, and Ti were calculated and, using the values, (g′+v′+z′)−(14×(w′−2×q′)) of the formula (A) and (g′+v′+z′)−(14×(w′−q′)) of the formula (B) were calculated. The columns “Formula A” and “Formula B” in Table 11 were filled with “G” (Good) when the calculated value is within the range of present invention, while the columns in Table 11 were filled with “B” (Bad) when the calculated value deviates from the range of present invention. As shown in Table 11, each of samples Nos. 40 to 43 and 44 to 47 has the almost same composition, except that the samples differ in the amount of B.

TABLE 11

| | Component (% by mass) | | | | | | | | | | | | |
|---|---|---|---|---|---|---|---|---|---|---|---|---|---|
| Sample | | | | R | B | Ga | Al | Co | Ti | Fe | M | | |
| No. | Nd | Pr | Dy | u | w | x | z | v | q | g | j | Cu | Cr |
| 40 | 19.7 | 6.6 | 4.5 | 30.8 | 0.93 | 0.48 | 0.23 | 0.91 | 0.25 | 66.1 | 0.46 | 0.10 | 0.00 |
| 41 | 19.8 | 6.6 | 4.5 | 30.9 | 0.94 | 0.48 | 0.23 | 0.91 | 0.25 | 66.0 | 0.47 | 0.10 | 0.01 |
| 42 | 19.8 | 6.6 | 4.6 | 31.0 | 0.97 | 0.48 | 0.24 | 0.92 | 0.25 | 66.1 | 0.44 | 0.10 | 0.00 |
| 43 | 19.8 | 6.6 | 4.6 | 30.9 | 0.99 | 0.48 | 0.24 | 0.92 | 0.25 | 66.1 | 0.44 | 0.10 | 0.01 |
| 44 | 18.7 | 6.3 | 6.0 | 31.0 | 0.93 | 0.48 | 0.23 | 0.91 | 0.25 | 65.6 | 0.45 | 0.10 | 0.01 |
| 45 | 18.6 | 6.2 | 6.0 | 30.9 | 0.94 | 0.48 | 0.24 | 0.91 | 0.25 | 65.8 | 0.45 | 0.10 | 0.00 |
| 46 | 18.6 | 6.2 | 6.0 | 30.9 | 0.96 | 0.48 | 0.23 | 0.91 | 0.25 | 65.7 | 0.45 | 0.10 | 0.01 |
| 47 | 18.6 | 6.2 | 6.1 | 30.9 | 0.98 | 0.48 | 0.23 | 0.91 | 0.25 | 65.6 | 0.44 | 0.10 | 0.00 |

| Sample | Component (% by mass) | | | | | Formula A | Formula B | |
|---|---|---|---|---|---|---|---|---|
| No. | Mn | Si | O | N | C | 0.06≦ | 0.10≧ | Note |
| 40 | 0.03 | 0.10 | 0.10 | 0.06 | 0.07 | G | G | Example |
| 41 | 0.03 | 0.10 | 0.11 | 0.05 | 0.07 | G | G | Example |
| 42 | 0.03 | 0.08 | 0.11 | 0.05 | 0.07 | G | G | Example |
| 43 | 0.03 | 0.07 | 0.11 | 0.06 | 0.07 | G | G | Example |
| 44 | 0.03 | 0.09 | 0.10 | 0.05 | 0.07 | G | G | Example |
| 45 | 0.03 | 0.09 | 0.11 | 0.05 | 0.07 | G | G | Example |
| 46 | 0.03 | 0.08 | 0.11 | 0.05 | 0.07 | G | G | Example |
| 47 | 0.03 | 0.08 | 0.11 | 0.05 | 0.07 | G | G | Example |

The sintered magnet thus obtained was subjected to a heat treatment of retaining 1,000° C. for 2 hours and cooling to room temperature, followed by retaining at 500° C. for 2 hours and cooling to room temperature. The sintered magnet thus obtained after the heat treatment was machined to produce samples of 7 mm in length×7 mm in width×7 mm in thickness and magnetized under a pulse magnetic field of 3.2 MA/m, and then Bᵣ of each sample was measured by a B-H tracer and H_{cJ} of each sample was measured by a pulse B-H tracer. The measurements results are shown in Table 12. Component analysis and gas analysis of each R-T-B based sintered magnet subjected to the measurement of Bᵣ and H_{cJ} were performed. The results were the same as those of component analysis and gas analysis of the R-T-B based sintered magnet material in Table 12. Furthermore, the change in H_{cJ} to the change in the amount of B is shown in ΔH_{cJ}/0.01B of Table 12.

TABLE 12

| | | | | | ΔH_{cJ}/ | |
|---|---|---|---|---|---|---|
| Sample | B (Atomic | Ti | Br | H_{cJ} | 0.01B | |
| No. | %) | (Atomic %) | (T) | (kA/m) | (kA/m) | Note |
| 40 | 0.93 | 0.25 | 1.25 | 2,215 | 14 | Example |
| 41 | 0.94 | 0.25 | 1.26 | 2,222 | | Example |
| 42 | 0.97 | 0.25 | 1.26 | 2,240 | | Example |
| 43 | 0.99 | 0.25 | 1.26 | 2,212 | | Example |
| 44 | 0.93 | 0.25 | 1.21 | 2,448 | 11 | Example |
| 45 | 0.94 | 0.25 | 1.22 | 2,458 | | Example |
| 46 | 0.96 | 0.25 | 1.22 | 2,481 | | Example |
| 47 | 0.98 | 0.25 | 1.22 | 2,468 | | Example |

As shown in Table 12, sample of Example according to this embodiment exhibits small change in ΔH_{cJ}/0.01B of 14 kA/m and 11 kA/m, and also has high Bᵣ and high H_{cJ}.

### 2. Examples According to Second Embodiment

### Example 1

After weighing raw materials of each element so as to obtain an alloy composition shown in A and B of Table 13, alloys were prepared by a strip casting method. Each of the alloys thus obtained was coarsely pulverized by a hydrogen grinding method to obtain a coarsely pulverized powder. The coarsely pulverized powder was mixed with TiH₂ so that the composition of the mixed powder obtained after mixing with the coarsely pulverized powder of the thus obtained alloy A becomes the composition shown in samples Nos. 2 to 6 in Table 14 to prepare a mixed powder (mixed powder of a coarsely pulverized powder). Sample No. 1 is a coarsely pulverized powder of an alloy A and sample No. 7 is a coarsely pulverized powder of an alloy B, and TiH₂ is not mixed in both samples. Mixed powders of samples Nos. 2 to 6 and coarsely pulverized powders of samples Nos. 1 and 7 were finely pulverized by a jet mill to prepare mixed powders of samples Nos. 2 to 6 (mixed powders of finely pulverized powders), and finely pulverized powders of samples Nos. 1 and 7, having a grain size D50 (volume median value obtained by a laser diffraction method using an air flow dispersion method, the same shall apply hereinafter) of 4.2 μm,

TABLE 13

| | Composition of alloy (% by mass) | | | | | | | |
|---|---|---|---|---|---|---|---|---|
| Alloy No. | Nd | Pr | B | Ga | Co | Al | Cu | Fe |
| A | 25.0 | 5.8 | 0.95 | 0.4 | 0.5 | 0.12 | 0.10 | Balance |
| B | 25.0 | 5.8 | 0.88 | 0.4 | 0.5 | 0.12 | 0.10 | Balance |

TABLE 14

| Sample | Alloy | Composition of mixed powder (% by mass) | | | | | | | | | |
|---|---|---|---|---|---|---|---|---|---|---|---|
| No. | No. | Nd | Pr | B | Ga | Co | Al | Cu | Ti | Fe | Note |
| 1 | A | 25.0 | 5.8 | 0.95 | 0.4 | 0.5 | 0.12 | 0.10 | — | Balance | Comparative |
| | | | | | | | | | | | Example |
| 2 | A | 25.0 | 5.8 | 0.95 | 0.4 | 0.5 | 0.12 | 0.10 | 0.18 | Balance | Example |
| 3 | A | 25.0 | 5.8 | 0.95 | 0.4 | 0.5 | 0.12 | 0.10 | 0.22 | Balance | Example |
| 4 | A | 25.0 | 5.8 | 0.95 | 0.4 | 0.5 | 0.12 | 0.10 | 0.25 | Balance | Example |
| 5 | A | 25.0 | 5.8 | 0.95 | 0.4 | 0.5 | 0.12 | 0.10 | 0.27 | Balance | Example |
| 6 | A | 25.0 | 5.8 | 0.95 | 0.4 | 0.5 | 0.12 | 0.10 | 0.30 | Balance | Example |
| 7 | B | 25.0 | 5.8 | 0.88 | 0.4 | 0.5 | 0.12 | 0.10 | — | Balance | Comparative |
| | | | | | | | | | | | Example |

The mixed powders of samples Nos. 2 to 6 and finely pulverized powders of samples Nos. 1 and 7 were molded at a magnetic field intensity of 0.8 MA/m under a pressure of 49 MPa (0.5 ton/cm²) using a perpendicular magnetic field molding device (transverse magnetic field molding device) to obtain two molded bodies of 12 mm in thickness×26 mm in width×55 mm in length for each (width direction is magnetic field application direction). The molded body thus obtained was sintered at 1,030° C. for 4 hours to obtain two R-T-B based sintered magnet materials for each based on mixed powders of samples Nos. 2 to 6 and finely pulverized powders of samples Nos. 1 and 7 (hereinafter sometimes referred to as an “R-T-B based sintered magnet material of sample No. **”, the same shall apply hereinafter).

To measure magnetic properties of R-T-B based sintered magnets of samples Nos. 1 to 7, each one of two R-T-B based sintered magnet materials of samples Nos. 1 to 7 was subjected to a heat treatment in a vacuum atmosphere at a temperature of 880° C. for 3 hours, cooled and then subjected to a heat treatment in a vacuum atmosphere at 500° C. for 2 hours. Each of the thus obtained R-T-B based sintered magnets based on R-T-B based sintered magnet materials of samples Nos. 1 to 7 (hereinafter sometimes referred to as an “R-T-B based sintered magnet material of sample No. **”, the same shall apply hereinafter) was cut, polished, and then processed into pieces of 7.0 mm in thickness×7.0 mm in width×7.0 mm in length. After processing, magnetic properties of R-T-B based sintered magnets of samples Nos. 1 to 7 were measured by a B-H tracer. The measurement results are shown in Table 15. In Hₖ/H_{cJ}, Hₖ is the value of H at the position where J becomes the value of 0.9×Jᵣ (Jᵣ is residual magnetization, Jᵣ=Bᵣ) in a second quadrant of a J (magnitude of magnetization)−H (intensity of magnetic field) curve (the same shall apply hereinafter).

TABLE 15

| | Bᵣ | H_{cJ} | Hₖ | | |
|---|---|---|---|---|---|
| Sample No. | (T) | (kA/m) | (kA/m) | Hₖ/H_{cJ} | Note |
| 1 | 1.410 | 1,175 | 1,139 | 0.97 | Comparative |
| | | | | | Example |
| 2 | 1.399 | 1,313 | 1,282 | 0.98 | Example |
| 3 | 1.389 | 1,451 | 1,426 | 0.98 | Example |
| 4 | 1.393 | 1,454 | 1,425 | 0.98 | Example |
| 5 | 1.396 | 1,450 | 1,422 | 0.98 | Example |
| 6 | 1.385 | 1,394 | 1,372 | 0.98 | Example |
| 7 | 1.380 | 1,450 | 1,420 | 0.98 | Comparative |
| | | | | | Example |

As is apparent from Table 15, R-T-B based sintered magnets obtained by mixing an alloy powder with TiH₂, followed by molding, sintering, and a heat treatment (samples Nos. 2 to 6, Invented Examples) exhibit H_{cJ} improved significantly as compared with those obtained by mixing with no TiH₂ powder (sample No. 1, Comparative Example). It is also apparent that H_{cJ} is particularly improved when the amount of Ti included in 100% by mass of the mixed powder is in a range of 0.22 to 0.27. Furthermore, although Bᵣ is slightly reduced by the addition of TiH₂, a reduction in Bᵣ does not significantly contribute to the effect of improving H_{cJ}. Namely, H_{cJ} is improved while suppressing a reduction in Bᵣ. Furthermore, all samples have high Hₖ/H_{cJ} such as 0.98. Sample No. 7 is Reproduction Example of Patent Document 1 and the amount of B is lower than that of the other sample (0.88% by mass). As shown in Table 15H_{cJ} and Bᵣ of the R-T-B based sintered magnet of sample No. 7 before RH supply and diffusion treatment are almost the same as those of this embodiment.

Next, each one of two R-T-B based sintered magnet materials of samples Nos. 1 to 7 was cut, polished, and then processed into pieces of 7.4 mm in thickness×7.4 mm in width×7.4 mm in length. After processing, regarding each of R-T-B based sintered magnet materials of samples Nos. 1 to 7, seven kinds of laminates were prepared by laminating a RH diffusion source made of sheet-like Dy metal, a retaining member, an R-T-B based sintered magnet material, a retaining member, and an RH diffusion source made of sheet-like Dy metal on a Mo sheet in this order. A plain-woven wire netting made of Mo was used as the retaining member. The seven kinds of laminates were charged into a heat treatment furnace and then subjected to an RH supply and diffusion treatment in a vacuum atmosphere under a pressure of 0.1 Pa at a temperature of 880° C. for 5.5 hours. After cooling the inside of the furnace, only R-T-B based sintered magnet materials of samples Nos. 1 to 7 were taken out. After the RH supply and diffusion treatment, R-T-B based sintered magnet materials of samples Nos. 1 to 7 were subjected to an RH diffusion treatment in a vacuum atmosphere at a temperature of 880° C. for 5 hours, cooled, and then subjected to a heat treatment in a vacuum atmosphere at 500° C. for 2 hours to obtain R-T-B based sintered magnets of No. 1 to 7. The entire surface of the thus obtained R-T-B based sintered magnets of samples Nos. 1 to 7 was cut by 0.2 mm each to thereby process into pieces of 7.0 mm in thickness×7.0 mm in width×7.0 mm in length. After processing, magnetic properties of R-T-B based sintered magnets of samples Nos. 1 to 7 were measured by a pulse B-H tracer. The measurement results are shown in Table 16.

TABLE 16

| | Bᵣ | H_{cJ} | Hₖ | | |
|---|---|---|---|---|---|
| Sample No. | (T) | (kA/m) | (kA/m) | Hₖ/H_{cJ} | Note |
| 1 | 1.390 | 1,711 | 1,545 | 0.90 | Comparative |
| | | | | | Example |
| 2 | 1.384 | 1,792 | 1,639 | 0.92 | Example |
| 3 | 1.378 | 1,801 | 1,654 | 0.92 | Example |
| 4 | 1.369 | 1,805 | 1,669 | 0.92 | Example |
| 5 | 1.379 | 1,805 | 1,657 | 0.92 | Example |
| 6 | 1.364 | 1,790 | 1,546 | 0.92 | Example |
| 7 | 1.353 | 1,791 | 1,540 | 0.86 | Comparative |
| | | | | | Example |

As is apparent from Table 16, R-T-B based sintered magnets obtained by subjecting an R-T-B based sintered magnet material, which is obtained by mixing an alloy powder with TiH₂, followed by molding and further sintering, to an RH supply and diffusion treatment, an RH diffusion treatment, and a heat treatment (samples Nos. 2 to 6, Invented Examples) have high H_{cJ} as compared with those obtained by mixing with no TiH₂ powder (sample No. 1, Comparative Example). It is also apparent that the thus obtained R-T-B based sintered magnets have high Bᵣ and high Hₖ/H_{cJ} since Bᵣ and Hₖ/H_{cJ} are slightly reduced even after the RH supply and diffusion treatment. Meanwhile, the R-T-B based sintered magnet of sample No. 7, which is Reproduction Example of Patent Document 1, exhibits Hₖ/H_{cJ} decreased significantly as compared with that before RH supply and diffusion.

### Example 2

After weighing raw materials of each element so as to obtain an alloy composition shown in C of Table 17, alloys were prepared by a strip casting method. Each of the alloys thus obtained was coarsely pulverized by a hydrogen grinding method to obtain a coarsely pulverized powder. The coarsely pulverized powder was mixed with TiH₂ so that the composition of the mixed powder obtained after mixing with the coarsely pulverized powder of the thus obtained alloy C becomes the composition shown in Table 18 to prepare a mixed powder of samples Nos. 8 to 11 (mixed powder of a coarsely pulverized powder). Mixed powders of samples Nos. 8 to 11 were finely pulverized by a jet mill to prepare mixed powders of samples Nos. 8 to 11 (mixed powders of finely pulverized powders) having a grain size D50 of 4.2 μm.

TABLE 17

| | Composition of alloy (% by mass) | | | | | | | |
|---|---|---|---|---|---|---|---|---|
| Alloy No. | Nd | Pr | B | Ga | Co | Al | Cu | Fe |
| C | 25.0 | 5.8 | 0.93 | 0.2 | 2.0 | 0.12 | 0.10 | Balance |

TABLE 18

| Sample | Alloy | Composition of mixed powder (% by mass) | | | | | | | | | |
|---|---|---|---|---|---|---|---|---|---|---|---|
| No. | No. | Nd | Pr | B | Ga | Co | Al | Cu | Ti | Fe | Note |
| 8 | C | 25.0 | 5.8 | 0.93 | 0.2 | 2.0 | 0.12 | 0.10 | 0.12 | Balance | Invented |
| | | | | | | | | | | | Example |
| 9 | C | 25.0 | 5.8 | 0.93 | 0.2 | 2.0 | 0.12 | 0.10 | 0.18 | Balance | Invented |
| | | | | | | | | | | | Example |
| 10 | C | 25.0 | 5.8 | 0.93 | 0.2 | 2.0 | 0.12 | 0.10 | 0.24 | Balance | Invented |
| | | | | | | | | | | | Example |
| 11 | C | 25.0 | 5.8 | 0.93 | 0.2 | 2.0 | 0.12 | 0.10 | 0.30 | Balance | Invented |
| | | | | | | | | | | | Example |

In the same manner as in Example 1, mixed powders of samples Nos. 8 to 11 were molded and sintered, and then two R-T-B based sintered magnet materials for each based on mixed powders of samples Nos. 8 to 11 were prepared. To measure magnetic properties of R-T-B based sintered magnets of samples Nos. 8 to 11, each one of two R-T-B based sintered magnet materials of samples Nos. 8 to 11 was subjected to the same heat treatment and processing as in Example 1. Magnetic properties of the thus obtained R-T-B based sintered magnets of samples Nos. 8 to 11 were measured by a B-H tracer. The measurement results are shown in Table 19.

TABLE 19

| | Bᵣ | H_{cJ} | Hₖ | | |
|---|---|---|---|---|---|
| Sample No. | (T) | (kA/m) | (kA/m) | Hₖ/H_{cJ} | Note |
| 8 | 1.413 | 1,283 | 1,261 | 0.98 | Invented |
| | | | | | Example |
| 9 | 1.400 | 1,313 | 1,278 | 0.97 | Invented |
| | | | | | Example |
| 10 | 1.394 | 1,297 | 1,259 | 0.97 | Invented |
| | | | | | Example |
| 11 | 1.390 | 1,277 | 1,246 | 0.98 | Invented |
| | | | | | Example |

This Example is an example in which the amount of B (changed from 0.95 to 0.93), the amount of Ga (changed from 0.4 to 0.2), and the amount of Co (changed from 0.5 to 2.0) in the composition of the alloy A of Example 1 are made to be different. As shown in Table 19, although magnetic properties are slightly inferior as compared with magnetic properties of the R-T-B based sintered magnet based on the alloy A, excellent magnetic properties are obtained.

Next, each one of two R-T-B based sintered magnet materials of samples Nos. 8 to 11 was processed into the same shape as in Example 1, and then subjected to an RH supply and diffusion treatment, an RH diffusion treatment, and a heat treatment in the same manner as in Example 1. The thus obtained R-T-B based sintered magnets of samples Nos. 8 to 11 were processed in the same manner as in Example 1, and the magnetic properties were measured by a pulse B-H tracer. The measurement results are shown in Table 20.

TABLE 20

| | Bᵣ | H_{cJ} | Hₖ | | |
|---|---|---|---|---|---|
| Sample No. | (T) | (kA/m) | (kA/m) | Hₖ/H_{cJ} | Note |
| 8 | 0.395 | 1,769 | 1,609 | 0.91 | Invented |
| | | | | | Example |
| 9 | 0.386 | 1,807 | 1,661 | 0.92 | Invented |
| | | | | | Example |
| 10 | 0.387 | 1,778 | 1,628 | 0.92 | Invented |
| | | | | | Example |
| 11 | 0.381 | 1,761 | 1,606 | 0.91 | Invented |
| | | | | | Example |

As is apparent from Table 20, R-T-B based sintered magnets obtained by subjecting an R-T-B based sintered magnet material, which is obtained by mixing an alloy powder with TiH₂, followed by molding and further sintering, to an RH supply and diffusion treatment, have high H_{cJ} and high Hₖ/H_{cJ} while suppressing a reduction in Bᵣ.

### Example 3

After weighing raw materials of each element so as to obtain an alloy composition shown in D to F of Table 21, alloys were prepared by a strip casting method. Each of the alloys thus obtained was coarsely pulverized by a hydrogen grinding method to obtain a coarsely pulverized powder. The coarsely pulverized powder of the thus obtained alloys D to F was mixed with TiH₂ so that the composition of the mixed powder obtained after mixing with the coarsely pulverized powder of the thus obtained alloys becomes the composition shown in Table 22 to prepare mixed powders of samples Nos. 13 to 15, 17 to 20, and 22 to 25 (mixed powders of coarsely pulverized powders). Sample No. 12 is a coarsely pulverized powder of an alloy D, sample No. 16 is a coarsely pulverized powder of an alloy E, sample No. 21 is a coarsely pulverized powder of an alloy F, and TiH₂ is not mixed in any of these samples. The above-mentioned mixed powders and coarsely pulverized powders were finely pulverized by a jet mill to prepare mixed powders of samples Nos. 13 to 15, 17 to 20, and 22 to 25 (mixed powders of finely pulverized powders) and finely pulverized powders of samples Nos. 12, 16, and 21, having a grain size D50 of 4.2 μm.

TABLE 21

| | Composition of alloy (% by mass) | | | | | | | |
|---|---|---|---|---|---|---|---|---|
| Alloy No. | Nd | Pr | B | Ga | Co | Al | Cu | Fe |
| D | 25.0 | 5.8 | 0.91 | 0.4 | 2.0 | 0.12 | 0.10 | Balance |
| E | 25.0 | 5.8 | 0.93 | 0.4 | 2.0 | 0.12 | 0.10 | Balance |
| F | 25.0 | 5.8 | 0.96 | 0.4 | 2.0 | 0.12 | 0.10 | Balance |

TABLE 22

| Sample | Alloy | Composition of mixed powder (% by mass) | | | | | | | | | |
|---|---|---|---|---|---|---|---|---|---|---|---|
| No. | No. | Nd | Pr | B | Ga | Co | Al | Cu | Ti | Fe | Note |
| 12 | D | 25.0 | 5.8 | 0.91 | 0.4 | 2.0 | 0.12 | 0.10 | — | Balance | Comparative |
| | | | | | | | | | | | Example |
| 13 | D | 25.0 | 5.8 | 0.91 | 0.4 | 2.0 | 0.12 | 0.10 | 0.06 | Balance | Invented |
| | | | | | | | | | | | Example |
| 14 | D | 25.0 | 5.8 | 0.91 | 0.4 | 2.0 | 0.12 | 0.10 | 0.14 | Balance | Invented |
| | | | | | | | | | | | Example |
| 15 | D | 25.0 | 5.8 | 0.91 | 0.4 | 2.0 | 0.12 | 0.10 | 0.21 | Balance | Invented |
| | | | | | | | | | | | Example |
| 16 | E | 25.0 | 5.8 | 0.93 | 0.4 | 2.0 | 0.12 | 0.10 | — | Balance | Comparative |
| | | | | | | | | | | | Example |
| 17 | E | 25.0 | 5.8 | 0.93 | 0.4 | 2.0 | 0.12 | 0.10 | 0.12 | Balance | Invented |
| | | | | | | | | | | | Example |
| 18 | E | 25.0 | 5.8 | 0.93 | 0.4 | 2.0 | 0.12 | 0.10 | 0.18 | Balance | Invented |
| | | | | | | | | | | | Example |
| 19 | E | 25.0 | 5.8 | 0.93 | 0.4 | 2.0 | 0.12 | 0.10 | 0.25 | Balance | Invented |
| | | | | | | | | | | | Example |
| 20 | E | 25.0 | 5.8 | 0.93 | 0.4 | 2.0 | 0.12 | 0.10 | 0.31 | Balance | Comparative |
| | | | | | | | | | | | Example |
| 21 | F | 25.0 | 5.8 | 0.96 | 0.4 | 2.0 | 0.12 | 0.10 | — | Balance | Comparative |
| | | | | | | | | | | | Example |
| 22 | F | 25.0 | 5.8 | 0.96 | 0.4 | 2.0 | 0.12 | 0.10 | 0.12 | Balance | Invented |
| | | | | | | | | | | | Example |
| 23 | F | 25.0 | 5.8 | 0.96 | 0.4 | 2.0 | 0.12 | 0.10 | 0.18 | Balance | Invented |
| | | | | | | | | | | | Example |
| 24 | F | 25.0 | 5.8 | 0.96 | 0.4 | 2.0 | 0.12 | 0.10 | 0.25 | Balance | Invented |
| | | | | | | | | | | | Example |
| 25 | F | 25.0 | 5.8 | 0.96 | 0.4 | 2.0 | 0.12 | 0.10 | 0.31 | Balance | Comparative |
| | | | | | | | | | | | Example |

Mixed powders of samples Nos. 13 to 15, 17 to 20, and 22 to 25, and finely pulverized powders of samples Nos. 12, 16, and 21 were molded and then sintered in the same manner as in Example 1 to prepare R-T-B based sintered magnet materials based on mixed powders of samples Nos. 13 to 15, 17 to 20, and 22 to 25, and finely pulverized powders of samples Nos. 12, 16, and 21.

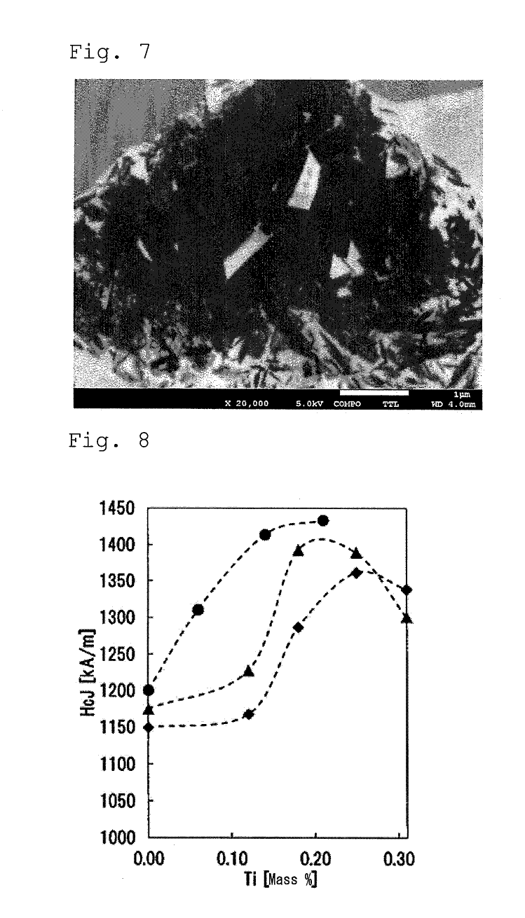

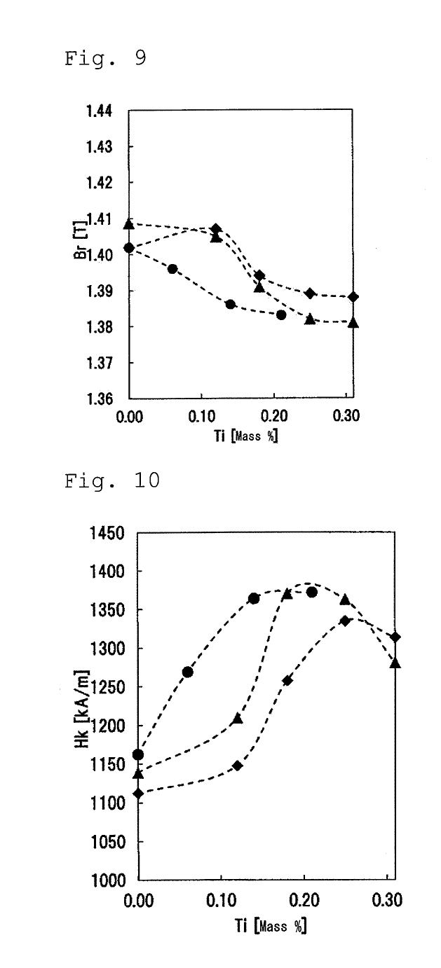

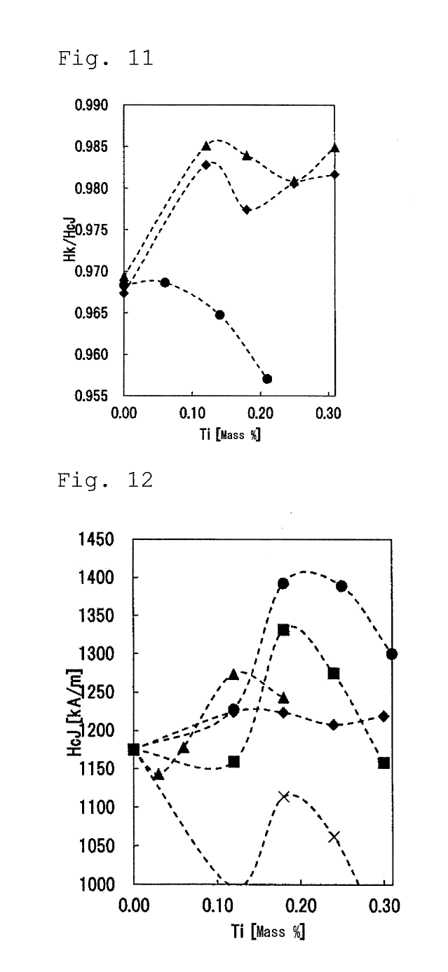

To measure magnetic properties of R-T-B based sintered magnets of samples Nos. 12 to 25, R-T-B based sintered magnet materials of samples Nos. 12 to 25 were subjected to the same heat treatment and processing as in Example 1. Magnetic properties of the thus obtained R-T-B based sintered magnets of samples Nos. 12 to 25 were measured by a B-H tracer. The measurement results are shown in FIG. 8 to FIG. 11 and Table 23. The horizontal axis indicates the amount of Ti and the vertical axis indicates the measurement results of H_{cJ} in FIG. 8, the horizontal axis indicates the amount of Ti and the vertical axis indicates the measurement results of Bᵣ in FIG. 9, the horizontal axis indicates the amount of Ti and the vertical axis indicates the measurement results of Hₖ in FIG. 10, and the horizontal axis indicates the amount of Ti and the vertical axis indicates the measurement results of Hₖ/H_{cJ} in FIG. 11. In FIG. 8 to FIG. 11, round shaped plots indicate samples Nos. 12 to 15, triangular shaped plots indicate samples Nos. 16 to 20, and diamond shaped plots indicate samples Nos. 21 to 25.

TABLE 23

| | Bᵣ | H_{cJ} | Hₖ | | |
|---|---|---|---|---|---|
| Sample No. | (T) | (kA/m) | (kA/m) | Hₖ/H_{cJ} | Note |
| 12 | 1.402 | 1,201 | 1,163 | 0.97 | Comparative |
| | | | | | Example |
| 13 | 1.396 | 1,311 | 1,270 | 0.97 | Invented |
| | | | | | Example |
| 14 | 1.386 | 1,414 | 1,364 | 0.96 | Invented |
| | | | | | Example |
| 15 | 1.383 | 1,434 | 1,372 | 0.96 | Invented |
| | | | | | Example |
| 16 | 1.409 | 1,175 | 1,139 | 0.97 | Comparative |
| | | | | | Example |
| 17 | 1.405 | 1,228 | 1,209 | 0.99 | Invented |
| | | | | | Example |
| 18 | 1.391 | 1,393 | 1,370 | 0.98 | Invented |
| | | | | | Example |
| 19 | 1.382 | 1,389 | 1,363 | 0.98 | Invented |
| | | | | | Example |
| 20 | 1.381 | 1,301 | 1,281 | 0.98 | Comparative |
| | | | | | Example |
| 21 | 1.402 | 1,150 | 1,112 | 0.97 | Comparative |
| | | | | | Example |
| 22 | 1.407 | 1,168 | 1,148 | 0.98 | Invented |
| | | | | | Example |
| 23 | 1.394 | 1,287 | 1,258 | 0.98 | Invented |
| | | | | | Example |
| 24 | 1.389 | 1,361 | 1,335 | 0.98 | Invented |
| | | | | | Example |
| 25 | 1.388 | 1,338 | 1,314 | 0.98 | Comparative |
| | | | | | Example |

This Example is an example in which the amount of B of an alloy is changed. As is apparent from FIG. 8, R-T-B based sintered magnets obtained by mixing an alloy powder with TiH₂, followed by molding, sintering, and a heat treatment (samples Nos. 13 to 15, 17 to 20, and 22 to 25, Invented Examples) exhibit H_{cJ} improved significantly even in any amount of B as compared with those obtained by mixing with no TiH₂ powder (samples Nos. 12, 16, and 21, Comparative Examples). It is also apparent that H_{cJ} is particularly improved when the amount of Ti included in 100% by mass of the mixed powder is in a range of 0.18 to 0.25.

As shown in FIG. 9, although Bᵣ is slightly reduced in the R-T-B based sintered magnet according to this embodiment, a reduction in Bᵣ does not significantly contribute to the effect of improving H_{cJ}. Namely, H_{cJ} is improved while suppressing a reduction in Bᵣ. Furthermore, samples have high Hₖ as shown in FIG. 10, and all samples have high Hₖ/H_{cJ} such as 0.95 as shown in FIG. 11.

### Example 4

A coarsely pulverized powder of an alloy E of Example 3 was mixed with each powder of TiH₂, TiO₂, TiB₂, TiC, and TiN so that Ti included in 100% by mass of the mixed powder becomes 0 to 0.3 (TiH₂ becomes 0 to 0.31, and TiO₂ becomes 0 to 0.18) after mixing, and then subjected to fine pulverization, molding, sintering, and a heat treatment in the same manner as in Example 1 to obtain an R-T-B based sintered magnet. H_{cJ} of the thus obtained R-T-B based sintered magnet was measured by a B-H tracer. The measurement results are shown in FIG. 12 and Table 24. In FIG. 12, the horizontal axis indicates the amount of Ti, the vertical axis indicates the measurement results of H_{cJ}, round shaped plots indicate TiH₂, triangular shaped plots indicate TiO₂, diamond shaped plots indicate TiB₂, square shaped plots indicate TiC, and X-mark plots indicate the case of being mixed with TiN.

TABLE 24

| | | Ti amount | H_{cJ} | |
|---|---|---|---|---|
| Sample No. | Mixed compound | (% by mass) | (kA/m) | Note |
| 26 | None | 0 | 1,175 | Comparative |
| | | | | Example |
| 27 | TiH₂ | 0.12 | 1,228 | Invented |
| | | | | Example |
| 28 | | 0.18 | 1,393 | Invented |
| | | | | Example |
| 29 | | 0.25 | 1,389 | Invented |
| | | | | Example |
| 30 | | 0.31 | 1,301 | Invented |
| | | | | Example |
| 31 | TiO₂ | 0.03 | 1,143 | Comparative |
| | | | | Example |
| 32 | | 0.05 | 1,178 | Comparative |
| | | | | Example |
| 33 | | 0.12 | 1,274 | Comparative |
| | | | | Example |
| 34 | | 0.18 | 1,243 | Comparative |
| | | | | Example |
| 35 | TiB₂ | 0.12 | 1,224 | Comparative |
| | | | | Example |
| 36 | | 0.18 | 1,224 | Comparative |
| | | | | Example |
| 37 | | 0.24 | 1,208 | Comparative |
| | | | | Example |
| 38 | | 0.30 | 1,219 | Comparative |
| | | | | Example |
| 39 | TiC | 0.12 | 1,159 | Comparative |
| | | | | Example |
| 40 | | 0.18 | 1,332 | Comparative |
| | | | | Example |
| 41 | | 0.24 | 1,275 | Comparative |
| | | | | Example |
| 42 | | 0.30 | 1,158 | Comparative |
| | | | | Example |
| 43 | TiN | 0.12 | 997 | Comparative |
| | | | | Example |
| 44 | | 0.18 | 1,114 | Comparative |
| | | | | Example |
| 45 | | 0.24 | 1,062 | Comparative |
| | | | | Example |
| 46 | | 0.30 | 925 | Comparative |
| | | | | Example |

As is apparent from FIG. 12, H_{cJ} is significantly improved when mixing with TiH₂. As mentioned above, oxygen, boron, carbon, nitrogen, and the like included in TiO₂, TiB₂, TiC, and TiN may remain in the magnet even after sintering, thus degrading magnetic properties of the thus obtained magnet. TiH₂ used in this embodiment is decomposed into Ti and H₂ (hydrogen) during the sintering step, and hydrogen is released into a sintering furnace from the magnet, and discharged finally out of the sintering furnace. Therefore, magnetic properties may be scarcely degraded.

### Example 5

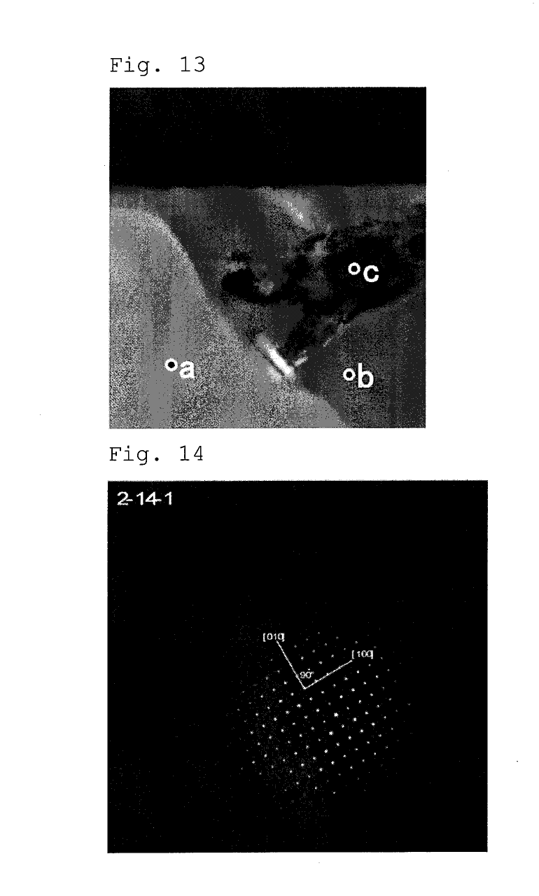

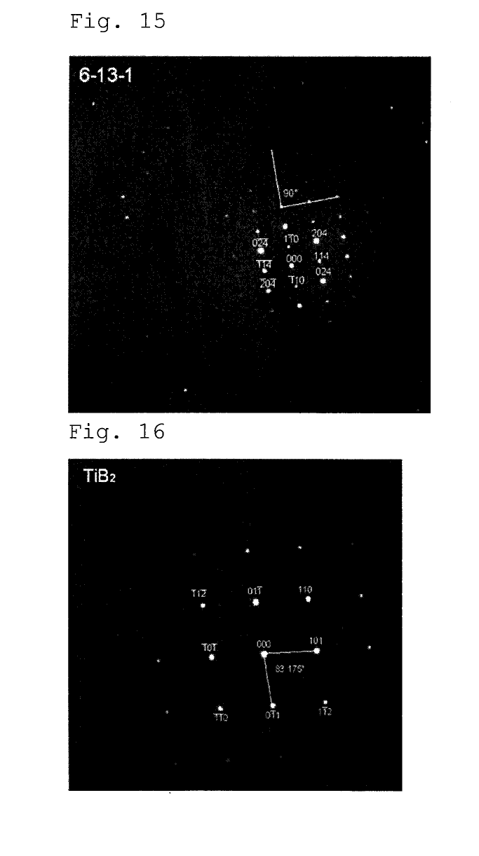

Regarding the R-T-B based sintered magnet of sample No. 18 of Example 3, the structure was observed by e FE-TEM (field emission-type transmission electron microscope, HF-2100, manufactured by Hitachi High-Technologies Corporation.). The results (DF-STEM image) are shown in FIG. 13. Regarding sites “a”, “b”, and “c” shown in FIG. 13, composition analysis was performed by energy dispersive X-ray spectrometry (EDS). The results are shown in Table 25. Regarding sites “a” and “b”, analysis of B is not performed. Regarding sites “a”, “b”, and “c”, diffraction pattern characterizing a crystal structure of electron diffraction was photographed. The results are shown in FIGS. 14 to 16. FIG. 14 shows a diffraction patter of the site “a”, FIG. 15 shows a diffraction patter of the site “b”, and FIG. 16 shows a diffraction patter of the site “c”.

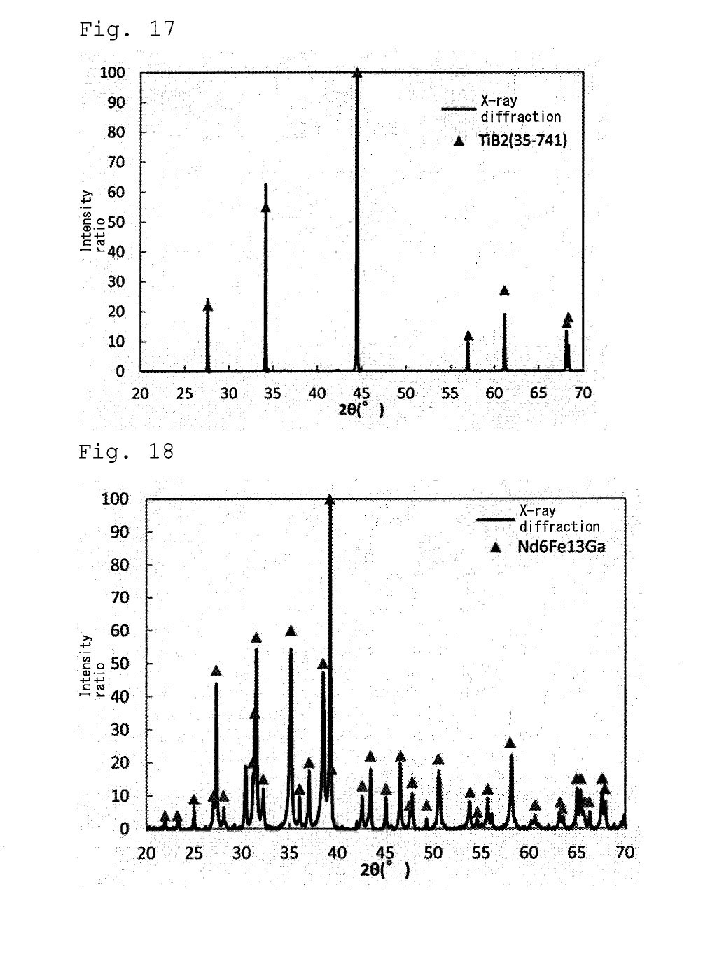

To identify the compound, composition analysis of a standard sample of an R₆T₁₃M compound and a standard sample of a boride of Ti was performed by EDS in the same manner as mentioned above. The results are shown in Table 26. Commercially available TiB₂ was used as a standard sample of a boride of Ti. Just in case, it was confirmed by X-ray diffraction using an X-ray diffractometer that commercially available TiB₂ must be a TiB₂ compound. The results of X-ray diffraction are shown in FIG. 17. Using, as the standard sample of the R₆T₁₃M compound, Nd as R, Fe as T, and Ga as M, Nd, Fe, and Ga were weighed so as to achieve Nd: 52.1, Fe: 43.7, and Ga: 4.2 as the theoretical value, in % by mass, of the Nd₆Fe₁₃Ga compound, and then melted to prepare an alloy. The analysis results of the thus obtained alloy are shown in Table 27. It was confirmed by the measurement of X-ray diffraction of this alloy that the alloy must be an Nd₆Fe₁₃Ga compound having a La₆Co₁₁Ga₃ type crystal structure. The results of X-ray diffraction are shown in FIG. 18.

TABLE 25

| | Component analysis results (% by mass) | | | | | | | |
|---|---|---|---|---|---|---|---|---|
| Site | Fe | Nd | Pr | Ga | Co | Cu | Ti | B |
| a | 59.2 | 29.0 | 4.3 | 0.7 | 1.9 | 0.2 | 0.1 | — |
| b | 31.5 | 46.6 | 15.9 | 3.5 | 1.1 | 0.2 | 0.2 | — |
| c | 0 | 0 | 0 | 0 | 0 | 0 | 18.8 | 77.3 |

TABLE 26

| Standard | Component analysis results (% by mass) | | | | | | | |
|---|---|---|---|---|---|---|---|---|
| sample | Fe | Nd | Pr | Ga | Co | Cu | Ti | B |
| Nd₆Fe₁₃Ga | 32.1 | 6.45 | 0 | 4.6 | 0 | 0 | 0 | 0 |
| TiB₂ | 0 | 0 | 0 | 0 | 0 | 0 | 19.6 | 80.4 |

TABLE 27

Composition (% by mass)

| Standard sample | | Nd | Fe | Ga |
|---|---|---|---|---|
| Nd₆Fe₁₃Ga | Theoretical value | 52.1 | 43.7 | 4.2 |
| | Analytical value | 53.3 | 42.4 | 4.2 |

The results of composition analysis by EDS of the site “a” in Table 25 and the results of a diffraction pattern which characterizes a crystal structure of electron diffraction of the site “a” shown in FIG. 14 revealed that the site “a” corresponds to an Nd₂Fe₁₄B compound.

The results of composition analysis of Table 25 to Table 27 and the results of a diffraction pattern which characterizes a crystal structure of electron diffraction of the site “b” shown in FIG. 15 identified that the site “b” corresponds to an Nd₆Fe₁₃Ga compound. Although the amount of Nd in the results of composition analysis by EDS of the site “b” is slightly different from that in the results of composition analysis of a standard sample, constituent elements are mainly composed of R (Nd and Pr), Fe, and Ga, and the results of a diffraction pattern which characterizes a crystal structure of electron diffraction of the site “b” shown in FIG. 15 are the same as those in a crystal structure of the Nd₆Fe₁₃Ga compound, thus identifying that the site “b” corresponds to an Nd₆Fe₁₃Ga compound.

Furthermore, the results of composition analysis of Table 25 to Table 27, and the results of a diffraction pattern which characterizes a crystal structure of electron diffraction of the site “c” shown in FIG. 16 identified that the site “c” corresponds to a TiB₂ compound. Namely, the results of composition analysis by EDS of the site “c” are similar to the results of composition analysis of a standard sample and constituent elements are composed of Ti and B, and the results of a diffraction pattern which characterizes a crystal structure of electron diffraction of the site “c” shown in FIG. 16 are the same as those of a crystal structure of a TiB₂ compound, thus identifying that the site “c” corresponds to a TiB₂ compound.

As mentioned above, the addition of a Ti hydride powder leads to formation of an R₆T₁₃M compound (typically Nd₆Fe₁₃Ga compound) and a boride of Ti (typically, a TiB₂ compound) in sintering and/or heat treatment. Namely, it is apparent that an R-T-B based sintered magnet obtained by a method for producing an R-T-B based sintered magnet of this embodiment has a structure in which an R₂T₁₄B compound, an R₆T₁₃M compound, and a boride of Ti coexist.

### Example 6

An arbitrary cross section of R-T-B based sintered magnets of samples Nos. 1 to 7 of Example 1 (R-T-B based sintered magnet subjected to neither an RH supply and diffusion treatment nor an RH diffusion treatment) were subjected to mirror polishing, and the mirror surfaces thereof were partially subjected to ion beam proceeding by a cross section polisher (SM-09010, manufactured by JEOL. Ltd.). Next, the polished surfaces were observed (accelerating voltage: 5 kV, working distance: 4 mm, TTL mode, magnification: 2,000 times) by a field emission-type scanning electron microscope (FE-SEM), JSM-7001F, manufactured by JEOL. Ltd.). A reflected electron image (BSE image) was analyzed by image processing software (Scandium, manufactured by OLYMPUS SOFT IMAGING SOLUTIONS GMBH) using FE-SEM to thereby determine an area ratio of an R₆T₁₃M compound (typically, an Nd₆Fe₁₃Ga compound). The BSE image by FE-SEM is displayed more rightly as a mean atomic number of elements constituting the region increases, while the BSE image is displayed more darkly as a mean atomic number of elements constituting the region decreases. For example, a grain boundary phase (rare-earth-rich phase) is lightly displayed, while the main phase (R₂T₁₄B phase) and oxide are darkly displayed. The R₆T₁₃M compound is displayed with intermediate brightness. Regarding analysis by image processing software, after making a graph in which the horizontal axis shows brightness of the BSE image and the vertical axis shows frequency (area) by image processing, the R₆T₁₃M compound was searched by energy dispersive X-ray spectrometry (EDS) and an area ratio of the R₆T₁₃M compound was determined by correspondence to specific brightness in the graph. This analysis was performed with respective to a BSE image of different five visual fields on a cross section (wideness of each visual field is 45 μm×60 μm), and the value was regarded as an area ratio of the R₆T₁₃M compound. The results are shown in Table 28.

TABLE 28

| Sample No. | Area ratio of R₆T₁₃M (%) | Note |
|---|---|---|
| 1 | 1.50 | Comparative Example |
| 2 | 1.58 | Invented Example |
| 3 | 2.58 | Invented Example |
| 4 | 2.31 | Invented Example |
| 5 | 2.73 | Invented Example |
| 6 | 2.57 | Invented Example |
| 7 | 2.65 | Comparative Example |

As mentioned above, R-T-B based sintered magnets obtained by mixing an alloy powder with TiH₂, followed by molding, sintering, and a heat treatment (samples Nos. 2 to 6, Invented Examples) have a structure in which an R₂T₁₄B compound, an R₆T₁₃M compound, and a boride of Ti coexist. As shown in Table 28, an R₆T₁₃M compound exists in an area ratio of 1% or more, and when the R₆T₁₃M compound exists in an area ratio of 2% or more, particularly high H_{cJ} is exhibited. Meanwhile, regarding those obtained by mixing with no TiH₂ powder (sample No. 1, Comparative Example) and sample No. 7 which is Reproduction Example of Patent Document 1 (Comparative Example), although an R₆T₁₃M compound exists in an area ratio of 1% or more, a boride of Ti is not formed. It is considered that an R-T-B based sintered magnet according to this embodiment has high H_{cJ} and high Hₖ/H_{cJ} while suppressing a reduction in Bᵣ because of a structure in which an R₂T₁₄B compound, an R₆T₁₃M compound and a boride of Ti coexist, and the existing amount of the R₆T₁₃M compound.

### Example 7

Regarding R-T-B based sintered magnets of samples Nos. 8 to 11 of Example 2 (R-T-B based sintered magnets subjected to neither RH supply and diffusion treatment nor RH diffusion treatment), an area ratio of an R₆T₁₃M compound was determined in the same manner as in Example 6. The results are shown in Table 29.

TABLE 29

| Sample No. | Area ratio of R₆T₁₃M (%) | Note |
|---|---|---|
| 8 | 1.22 | Invented Example |
| 9 | 1.93 | Invented Example |
| 10 | 1.11 | Invented Example |
| 11 | 1.93 | Invented Example |

As mentioned above, R-T-B based sintered magnets obtained by mixing an alloy powder with TiH₂, followed by molding, sintering and a heat treatment (samples Nos. 8 to 11, Invented Examples) have a structure in which an R₂T₁₄B compound, an R₆T₁₃M compound and a boride of Ti coexist and, as shown in Table 29, an R₆T₁₃M compound exists in an area ratio of 1% or more.

### Example 8

After weighing raw materials of each element so as to obtain an alloy composition shown in G and H of Table 30, alloys were prepared by a strip casting method. Each of the alloys thus obtained was coarsely pulverized by a hydrogen grinding method to obtain a coarsely pulverized powder. The coarsely pulverized powder was mixed with TiH₂ so that the composition of the mixed powder obtained after mixing with the coarsely pulverized powder of the thus obtained alloy G becomes the composition shown in samples Nos. 48 to 52 in Table 31 to prepare a mixed powder (mixed powder of a coarsely pulverized powder). Sample No. 47 is a coarsely pulverized powder of an alloy G and sample No. 53 is a coarsely pulverized powder of an alloy H, and TiH₂ is not mixed in both samples. Mixed powders of samples Nos. 48 to 52 and coarsely pulverized powders of samples Nos. 47 and 53 were finely pulverized by a jet mill to prepare mixed powders of samples Nos. 48 to 52 (mixed powders of finely pulverized powders) and finely pulverized powders of samples Nos. 47 and 53, having a grain size D50 (volume median value obtained by a laser diffraction method using an air flow dispersion method, the same shall apply hereinafter) of 4.2 μm.

TABLE 30

| | Composition of alloy (% by mass) | | | | | | | |
|---|---|---|---|---|---|---|---|---|
| Alloy No. | Nd | Pr | B | Ga | Co | Al | Cu | Fe |
| G | 23.1 | 7.7 | 0.94 | 0.5 | 0.5 | 0.10 | 0.15 | Balance |
| H | 23.1 | 7.7 | 0.89 | 0.5 | 0.5 | 0.10 | 0.15 | Balance |

TABLE 31

| Sample | Alloy | Composition of mixed powder (% by mass) | | | | | | | | | |
|---|---|---|---|---|---|---|---|---|---|---|---|
| No. | No. | Nd | Pr | B | Ga | Co | Al | Cu | Ti | Fe | Note |
| 47 | G | 23.1 | 7.7 | 0.94 | 0.5 | 0.5 | 0.10 | 0.15 | — | Balance | Comparative |
| | | | | | | | | | | | Example |
| 48 | G | 23.1 | 7.7 | 0.94 | 0.5 | 0.5 | 0.10 | 0.15 | 0.16 | Balance | Invented |
| | | | | | | | | | | | Example |
| 49 | G | 23.1 | 7.7 | 0.94 | 0.5 | 0.5 | 0.10 | 0.15 | 0.19 | Balance | Invented |
| | | | | | | | | | | | Example |
| 50 | G | 23.1 | 7.7 | 0.94 | 0.5 | 0.5 | 0.10 | 0.15 | 0.22 | Balance | Invented |
| | | | | | | | | | | | Example |
| 51 | G | 23.1 | 7.7 | 0.94 | 0.5 | 0.5 | 0.10 | 0.15 | 0.24 | Balance | Invented |
| | | | | | | | | | | | Example |
| 52 | G | 23.1 | 7.7 | 0.94 | 0.5 | 0.5 | 0.10 | 0.15 | 0.27 | Balance | Invented |
| | | | | | | | | | | | Example |
| 53 | H | 23.1 | 7.7 | 0.99 | 0.5 | 0.5 | 0.10 | 0.15 | — | Balance | Comparative |
| | | | | | | | | | | | Example |

Mixed powders of samples Nos. 48 to 52 and coarsely pulverized powders of samples Nos. 47 and 53 were molded and then sintered in the same manner as in Example 1 to prepare R-T-B based sintered magnet materials based on mixed powders of samples Nos. 48 to 52 and coarsely pulverized powders of samples Nos. 47 and 53. To measure magnetic properties of R-T-B based sintered magnets of samples Nos. 47 to 53, R-T-B based sintered magnet materials of samples Nos. 47 to 53 were subjected to a heat treatment and processing in the same manner as in Example 1. Magnetic properties of the thus obtained R-T-B based sintered magnets of samples Nos. 47 to 53 were measured by a B-H tracer. The measurement results are shown in Table 32. An area ratio of an R₆T₁₃M compound was determined in the same manner as in Example 6. The results are shown in Table 32.

TABLE 32

| Sample | Bᵣ | H_{cJ} | Hₖ | | Area ratio of | |
|---|---|---|---|---|---|---|
| No. | (T) | (kA/m) | (kA/m) | Hₖ/H_{cJ} | R₆T₁₃M (%) | Note |
| 47 | 1.410 | 1,205 | 1,181 | 0.98 | 1.80 | Comparative |
| | | | | | | Example |
| 48 | 1.396 | 1,305 | 1,278 | 0.98 | 2.00 | Invented |
| | | | | | | Example |
| 49 | 1.392 | 1,428 | 1,402 | 0.98 | 2.43 | Invented |
| | | | | | | Example |
| 50 | 1.390 | 1,501 | 1,473 | 0.98 | 2.70 | Invented |
| | | | | | | Example |
| 51 | 1.380 | 1,523 | 1,493 | 0.98 | 2.90 | Invented |
| | | | | | | Example |
| 52 | 1.379 | 1,509 | 1,479 | 0.98 | 3.12 | Invented |
| | | | | | | Example |
| 53 | 1.380 | 1,522 | 1,370 | 0.90 | 3.00 | Comparative |
| | | | | | | Example |

This Example is an example in which the composition of the alloy A of Example 1 was changed, especially the amount of Ga was increased from 0.4% by mass to 0.5% by mass. As is apparent from Table 32, R-T-B based sintered magnets obtained by mixing an alloy powder with TiH₂, followed by molding, sintering, and a heat treatment (samples Nos. 48 to 52, Invented Examples) have high H_{cJ} as compared with an R-T-B based sintered magnet obtained by mixing with no TiH₂ powder (sample No. 47, Comparative Example). Meanwhile, an R-T-B based sintered magnet of sample No. 53, which is Reproduction Example of Patent Document 1, exhibits the same H_{cJ} and Bᵣ as those of Invented Examples, but exhibits significantly decreased Hₖ/H_{cJ}.

An R-T-B based sintered magnet according to this Example has high H_{cJ} of 1,500 kA/m or more while suppressing a reduction in Bᵣ, the amount of Ti being in a range of 0.22 to 0.27. For example, when a comparison is made between sample No. 50 of this Example in which the amount of Ti is the same as 0.22 and sample No. 3 of Example 1H_{cJ} is improved by about 50 kA/m while Bᵣ is scarcely decreased.

Furthermore, as mentioned above, R-T-B based sintered magnets obtained by mixing an alloy powder with TiH₂, followed by molding, sintering, and a heat treatment (samples Nos. 48 to 52, Invented Examples) have a structure in which an R₂T₁₄B compound, an R₆T₁₃M compound, and a boride of Ti coexist and, as shown in Table 32, the R₆T₁₃M compound exists in an area ratio of 2% or more.

### Example 9

After weighing raw materials of each element so as to obtain an alloy composition shown in I and J of Table 33, alloys were prepared by a strip casting method. Each of the alloys thus obtained was coarsely pulverized by a hydrogen grinding method to obtain a coarsely pulverized powder. The coarsely pulverized powder was mixed with TiH₂ so that the composition of the mixed powder obtained after mixing with the coarsely pulverized powder of the thus obtained alloy I becomes the composition shown in samples Nos. 55 to 59 in Table 34 to prepare a mixed powder (mixed powder of a coarsely pulverized powder). Sample No. 54 is a coarsely pulverized powder of an alloy I and sample No. 60 is a coarsely pulverized powder of an alloy J, and TiH₂ is not mixed in both samples. Mixed powders of samples Nos. 55 to 59 and coarsely pulverized powders of samples Nos. 54 and 60 were finely pulverized by a jet mill to prepare mixed powders of samples Nos. 55 to 59 (mixed powders of finely pulverized powders) and finely pulverized powders of samples Nos. 54 and 60, having a grain size D50 (volume median value obtained by a laser diffraction method using an air flow dispersion method, the same shall apply hereinafter) of 4.2 μm.

TABLE 33

| | Composition of alloy (% by mass) | | | | | | | |
|---|---|---|---|---|---|---|---|---|
| Alloy No. | Nd | Pr | B | Ga | Co | Al | Cu | Fe |
| I | 23.1 | 7.7 | 0.94 | 0.5 | 0.5 | 0.30 | 0.15 | Balance |
| J | 23.1 | 7.7 | 0.88 | 0.5 | 0.5 | 0.30 | 0.15 | Balance |

TABLE 34

| Sample | Alloy | Composition of mixed powder (% by mass) | | | | | | | | | |
|---|---|---|---|---|---|---|---|---|---|---|---|
| No. | No. | Nd | Pr | B | Ga | Co | Al | Cu | Ti | Fe | Note |
| 54 | I | 23.1 | 7.7 | 0.94 | 0.5 | 0.5 | 0.30 | 0.15 | — | Balance | Comparative |
| | | | | | | | | | | | Example |
| 55 | I | 23.1 | 7.7 | 0.94 | 0.5 | 0.5 | 0.30 | 0.15 | 0.16 | Balance | Invented |
| | | | | | | | | | | | Example |
| 56 | I | 23.1 | 7.7 | 0.94 | 0.5 | 0.5 | 0.30 | 0.15 | 0.19 | Balance | Invented |
| | | | | | | | | | | | Example |
| 57 | I | 23.1 | 7.7 | 0.94 | 0.5 | 0.5 | 0.30 | 0.15 | 0.22 | Balance | Invented |
| | | | | | | | | | | | Example |
| 58 | I | 23.1 | 7.7 | 0.94 | 0.5 | 0.5 | 0.30 | 0.15 | 0.24 | Balance | Invented |
| | | | | | | | | | | | Example |
| 59 | I | 23.1 | 7.7 | 0.94 | 0.5 | 0.5 | 0.30 | 0.15 | 0.27 | Balance | Invented |
| | | | | | | | | | | | Example |
| 60 | J | 23.1 | 7.7 | 0.88 | 0.5 | 0.5 | 0.30 | 0.15 | — | Balance | Comparative |
| | | | | | | | | | | | Example |

Mixed powders of samples Nos. 55 to 59 and coarsely pulverized powders of samples Nos. 54 and 60 were molded and then sintered in the same manner as in Example 1 to prepare R-T-B based sintered magnet materials based on mixed powders of samples Nos. 55 to 59 and coarsely pulverized powders of samples Nos. 54 and 60. To measure magnetic properties of R-T-B based sintered magnets of samples Nos. 54 to 60, R-T-B based sintered magnet materials of samples Nos. 54 to 60 were subjected to a heat treatment and processing in the same manner as in Example 1. Magnetic properties of the thus obtained R-T-B based sintered magnets of samples Nos. 54 to 60 were measured by a B-H tracer. The measurement results are shown in Table 35. An area ratio of an R₆T₁₃M compound was determined in the same manner as in Example 6. The results are shown in Table 35.

TABLE 35

| Sample | Bᵣ | H_{cJ} | Hₖ | | Area ratio of | |
|---|---|---|---|---|---|---|
| No. | (T) | (kA/m) | (kA/m) | Hₖ/H_{cJ} | R₆T₁₃M (%) | Note |
| 54 | 1.380 | 1,240 | 1,215 | 0.98 | 1.70 | Comparative |
| | | | | | | Example |
| 55 | 1.363 | 1,359 | 1,334 | 0.98 | 1.90 | Invented |
| | | | | | | Example |
| 56 | 1.373 | 1,497 | 1,443 | 0.96 | 2.63 | Invented |
| | | | | | | Example |
| 57 | 1.360 | 1,546 | 1,490 | 0.96 | 3.02 | Invented |
| | | | | | | Example |
| 58 | 1.361 | 1,540 | 1,514 | 0.98 | 3.14 | Invented |
| | | | | | | Example |
| 59 | 1.357 | 1,512 | 1,478 | 0.98 | 3.07 | Invented |
| | | | | | | Example |
| 60 | 1.361 | 1,542 | 1,357 | 0.88 | 3.11 | Comparative |
| | | | | | | Example |

This Example is an example in which the amount of Al of the alloy G of Example 8 was increased from 0.1% by mass to 0.3% by mass. As is apparent from Table 35, R-T-B based sintered magnets obtained by mixing an alloy powder with TiH₂, followed by molding, sintering, and a heat treatment (samples Nos. 55 to 59, Invented Examples) have high H_{cJ} as compared with an R-T-B based sintered magnet obtained by mixing with no TiH₂ powder (sample No. 54, Comparative Example). Meanwhile, an R-T-B based sintered magnet of sample No. 60, which is Reproduction Example of Patent Document 1, exhibits the same H_{cJ} and Bᵣ as those of Invented Examples, but exhibits significantly decreased Hₖ/H_{cJ}.

An R-T-B based sintered magnet according to this Example has H_{cJ} of about 1,500 kA/m when the amount of Ti is 0.19% by mass, and also has high H_{cJ} of about 1,500 kA/m or more when the amount of Ti is in a range of 0.22 to 0.27% by mass. Furthermore, as mentioned above, the R-T-B based sintered magnet according to this Example has a structure in which an R₂T₁₄B compound, an R₆T₁₃M compound, and a boride of Ti coexist. As shown in Table 35, in samples Nos. 56 to 59 having higher H_{cJ} in which an R₆T₁₃M compound exists in an area ratio of 1.9% or more, the R₆T₁₃M compound exists in an area ratio of 2% or more.

This application claims priority based on Japanese Patent Application No. 2014-037838, filed on Feb. 28, 2014 and Japanese Patent Application 2014-198073, filed on Sep. 29, 2014, the disclosure of which is incorporated by reference herein.

### INDUSTRIAL APPLICABILITY

The R-T-B based sintered magnet obtained by the present invention can be suitably employed in various motors such as voice coil motors (VCM) of hard disk drives, motors for electric cars, and motors for hybrid cars, and home appliances.

1. An R-T-B based sintered magnet, wherein the composition represented by the following formula (1) satisfies the following inequality expressions (2) to (9):
uRwBxGazAlvCoqTigFejM (1)
(R is at least one of rare-earth elements and indispensably includes Nd, M is an element except for R, B, Ga, Al, Co, Ti, and Fe, and u, w, x, z, v, q, g, and j are expressed in terms of % by mass)
0≦u≦32.0 (2)
(heavy rare-earth elements RH account for 10% by mass or less of the R-T-B based sintered magnet)
0.93≦w≦1.00 (3)
0.3≦x≦0.8 (4)
0.05≦z≦0.5 (5)
0≦v≦3.0 (6)
0.15≦q≦0.28 (7)
60.42≦g≦69.57 (8)
0≦j≦2.0 (9)
and, when the value obtained by dividing g by the atomic weight of Fe is g′, the value obtained by dividing v by the atomic weight of Co is v′, the value obtained by dividing z by the atomic weight of Al is z′, the value obtained by dividing w by the atomic weight of B is w′, and the value obtained by dividing q by the atomic weight of Ti is q′, the following inequality expressions (A) and (B) are satisfied:
0.06≦(g′+v′+z′)−(14×(w′−2×q′)) (A)
0.10≧(g′+v′+z′)−(14×(w′−q′)) (B)

2. The R-T-B based sintered magnet according to claim 1, wherein 0.18≦q≦0.28.

3. The R-T-B based sintered magnet according to claim 1, which has a structure in which:
an R₂T₁₄B compound (R is at least one of rare-earth elements and indispensably includes Nd, and T is at least one of transition metal elements and indispensably includes Fe),
an R₆T₁₃A compound (R is at least one of rare-earth elements and indispensably includes Nd, T is at least one of transition metal elements and indispensably includes Fe, and A is at least one of Ga, Al, Cu, and Si and indispensably includes Ga), and
a boride of Ti coexist.

4. The R-T-B based sintered magnet according to claim 1, wherein an area ratio of the R₆T₁₃A compound in an arbitrary cross section of the R-T-B based sintered magnet is 2% or more.

5. A method for producing an R-T-B based sintered magnet, which comprises the steps of:
preparing an alloy powder including:
R: 27 to 35% by mass (R is at least one of rare-earth elements and indispensably includes Nd),
B: 0.9 to 1.0% by mass,
Ga: 0.15 to 0.6% by mass, and
balance T (T is at least one of transition metal elements and indispensably includes Fe) and inevitable impurities;
preparing a powder of a hydride of Ti;
mixing the alloy powder with the powder of a hydride of Ti so as to adjust the amount of Ti included in 100% by mass of the mixed powder after mixing to 0.3% by mass or less to thereby prepare the mixed powder;
molding the mixed powder to prepare a molded body;
sintering the molded body to prepare an R-T-B based sintered magnet material; and
subjecting the R-T-B based sintered magnet material to a heat treatment.

6. The method for producing an R-T-B based sintered magnet according to claim 5, which comprises the steps of:
preparing an RH diffusion source comprising a metal, an alloy, or a compound, each containing Dy and/or Tb, in place of the step of subjecting the R-T-B based sintered magnet material to a heat treatment;
subjecting to an RH supply and diffusion treatment of supplying Dy and/or Tb of the RH diffusion source to the R-T-B based sintered magnet material, and diffusing Dy and/or Tb; and
subjecting the R-T-B based sintered magnet material after the RH supply and diffusion treatment step to a heat treatment.

7. The method for producing an R-T-B based sintered magnet according to claim 5, which includes:
B: 0.91 to 1.0% by mass.

8. The method for producing an R-T-B based sintered magnet according to claim 5, wherein the R-T-B based sintered magnet has a structure in which:
an R₂T₁₄B compound (R is at least one of rare-earth elements and indispensably includes Nd, and T is at least one of transition metal elements and indispensably includes Fe),
an R₆T₁₃M compound (R is at least one of rare-earth elements and indispensably includes Nd, T is at least one of transition metal elements and indispensably includes Fe, and M is at least one of Ga, Al, Cu, and Si and indispensably includes Ga), and
a boride of Ti.

9. The method for producing an R-T-B based sintered magnet according to claim 8, wherein an area ratio of the R₆T₁₃M compound in an arbitrary cross section of the R-T-B based sintered magnet is 1% or more.

10. The method for producing an R-T-B based sintered magnet according to claim 9, wherein an area ratio of the R₆T₁₃M compound in an arbitrary cross section of the R-T-B based sintered magnet is 2% or more.
